(19) United States
(12) Patent Application Publication
(10) Pub. No.: US 2024/0007148 A1
(43) Pub. Date: Jan. 4, 2024

(54) Beam Control for Communication via Reflective Surfaces

(71) Applicant: Apple Inc., Cupertino, CA (US)

(72) Inventors: Jan Ellenbeck, Gruenwald (DE); Stefan Meyer, Hoechstadt (DE); Bertram R Gunzelmann, Koenigsbrunn (DE)

(21) Appl. No.: 18/322,811

(22) Filed: May 24, 2023

Related U.S. Application Data
(60) Provisional application No. 63/358,040, filed on Jul. 1, 2022.

(51) Int. Cl. H04B 7/04; H04B 7/06

(52) U.S. Cl. CPC H04B 7/04013; H04B 7/06952

(57) ABSTRACT

A user equipment (UE) device may communicate with a wireless access point (AP) via reflection off a reconfigurable intelligent surface (RIS). The RIS may begin to sweep antenna elements over one or more sets of signal beams beginning at an initial time while reflecting signals transmitted by the AP. The UE may record times at which the UE receives reference signals reflected by the RIS. The UE may select an optimal signal beam of the RIS based on the time periods between the initial time and the times at which the reference signals were received. The UE may inform the AP of the optimal signal beam and the RIS may use the optimal signal beam to reflect wireless data between the AP and the UE. Multiple signal beam sweeps may eliminate uncertainty or ambiguity in signal beam selection associated with timing drift or offsets between the RIS and the UE.

This application claims the benefit of U.S. Provisional Patent Application No. 63/358,040, filed Jul. 1, 2022, which is hereby incorporated by reference herein in its entirety.

### FIELD

This disclosure relates generally to electronic devices and, more particularly, to electronic devices with wireless circuitry.

### BACKGROUND

Electronic devices can be provided with wireless capabilities. An electronic device with wireless capabilities has wireless circuitry that includes one or more antennas. The wireless circuitry is used to perform communications using radio-frequency signals conveyed by the antennas.

As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight and because electronic devices often move while performing wireless communications.

### SUMMARY

A user equipment (UE) device may communicate with a wireless access point (AP) using wireless signals transmitted using a data transfer radio access technology (RAT) at frequencies greater than about 100 GHz. When a line-of-sight path between the UE device and the AP is blocked, a reconfigurable intelligent surface (RIS) may be used to reflect the wireless signals of the data transfer RAT between the UE device and the AP. The RIS may also be used to reflect the wireless signals when reflection via the RIS exhibits superior propagation conditions than the line-of-sight path.

The RIS may transmit a control signal to the AP and the UE device that identifies a first time. At the first time, the AP may begin to transmit reference signals to the RIS. At the first time, the UE device may begin to listen for reference signals transmitted by the AP and reflected by the RIS. At the first time, the RIS may begin to sweep antenna elements over a first set of signal beams. The UE device may receive a reference signal reflected by the RIS at a second time. The UE device may identify a duration or time period that elapsed between the first time and the second time. If desired, the RIS may then sweep the antenna elements over a second set of signal beams. The second set of signal beams may include the same signal beams as the first set of signal beams (e.g., where the sweep over the second signal beams is in a reverse order relative to the sweep over the first set of signal beams). The UE device may receive a reference signal reflected by the RIS at a third time during the sweep over the second set of signal beams. The UE device may identify a duration or time period that elapsed between the first time and the third time. The UE device may then control the RIS to sweep over additional sets of signal beams if desired. The UE device may also sweep over its own signal beams at each step in the sweep by the RIS.

The UE device may select a signal beam from the first and second sets based on the duration between the first time and the second time and the duration between the first time and the third time. Performing multiple signal beam sweeps may eliminate uncertainty or ambiguity in the signal beam selection associated with timing drift or offsets between the RIS and the UE device. The UE device may transmit a control signal that identifies the selected signal beam to the AP. The AP or the UE device may configure the RIS to form the selected signal beam. The RIS may then use the selected signal beam to reflect wireless data between the UE device and the RIS. The selected signal beam may be updated as needed (e.g., when the UE device moves over time). In this way, the UE device may select the signal beam for the RIS without requiring time and resource-intensive handshake procedures after each step in the signal beam sweeps performed by the RIS, while also minimizing the cost, resource, and power consumption of the RIS.

An aspect of the disclosure provides a method of operating a first electronic device to wirelessly communicate with a second electronic device via reflection off a third electronic device. The method can include receiving, using a receiver, a first control signal from the third electronic device that identifies a first time. The method can include receiving, using one or more antennas at a second time subsequent to the first time, a radio-frequency signal transmitted by the second electronic device and reflected off the third electronic device. The method can include transmitting, using a transmitter, a second control signal that identifies a signal beam of the third electronic device associated with a duration between the first time and the second time.

An aspect of the disclosure provides a method of operating a first electronic device to reflect radio-frequency signals between a second electronic device and a third electronic device. The method can include sweeping an array of antenna elements over a first set of signal beams concurrent with the array of antenna elements reflecting radio-frequency signals transmitted by the second electronic device. The method can include after sweeping the array of antenna elements over the first set of signal beams, sweeping the array of antenna elements over a second set of signal beams concurrent with the array of antenna elements reflecting the radio-frequency signals transmitted by the second electronic device. The method can include receiving, using a receiver after sweeping the array of antenna elements over the second set of signal beams, a control signal that identifies a signal beam from the first and second sets of signal beams that overlaps the third electronic device.

An aspect of the disclosure provides a user equipment device. The user equipment device can include a phased antenna array. The phased antenna array can be configured to listen, beginning at a first time, for radio-frequency signals transmitted by a wireless access point and reflected off a reconfigurable intelligent surface (RIS) concurrent with a sweep by the RIS over a set of signal beams formable by antenna elements on the RIS. The phased antenna array can be configured to receive, at a second time subsequent to the first time, the radio-frequency signals transmitted by the wireless access point and reflected off the RIS. The user equipment device can include one or more processors. The one or more processors can be configured to select a signal beam from the set of signal beams based on a time period between the first time and the second time and based on a predetermined timing of the sweep by the RIS over the set of signal beams. The one or more processors can be configured to transmit, to the wireless access point, a control signal that identifies the selected signal beam.

### BRIEF DESCRIPTION OF THE DRAWINGS

FIG. 1 is a schematic block diagram of an illustrative wireless access point and user equipment device that wirelessly communicate at frequencies greater than about 100 GHz in accordance with some embodiments.

FIG. 2 is a top view of an illustrative antenna that transmits wireless signals at frequencies greater than about 100 GHz based on optical local oscillator (LO) signals in accordance with some embodiments.

FIG. 3 is a top view showing how an illustrative antenna of the type shown in FIG. 2 may convert received wireless signals at frequencies greater than about 100 GHz into intermediate frequency signals based on optical LO signals in accordance with some embodiments.

FIG. 4 is a top view showing how multiple antennas of the type shown in FIGS. 2 and 3 may be stacked to cover multiple polarizations in accordance with some embodiments.

FIG. 5 is a top view showing how stacked antennas of the type shown in FIG. 4 may be integrated into a phased antenna array for conveying wireless signals at frequencies greater than about 100 GHz within a corresponding signal beam.

FIG. 6 is a circuit diagram of illustrative wireless circuitry having an antenna that transmits wireless signals at frequencies greater than about 100 GHz and that receives wireless signals at frequencies greater than about 100 GHz for conversion to intermediate frequencies and then to the optical domain in accordance with some embodiments.

FIG. 7 is a circuit diagram of an illustrative phased antenna array that conveys wireless signals at frequencies greater than about 100 GHz within a corresponding signal beam in accordance with some embodiments.

FIG. 8 is a diagram showing how an illustrative reconfigurable intelligent surface (RIS) may reflect wireless signals at frequencies greater than about 100 GHz between a wireless access point and a user equipment device in accordance with some embodiments.

FIG. 9 is a diagram showing how an illustrative RIS may include an array of antenna elements configured to passively reflect wireless signals at frequencies greater than about 100 GHz in different directions in accordance with some embodiments.

FIG. 10 is a diagram showing how an illustrative wireless access point, RIS, and user equipment device may communicate using both a data transfer radio access technology (RAT) and a control RAT in accordance with some embodiments.

FIG. 11 is a flow chart of illustrative operations that may be performed by a wireless access point and a user equipment device to establish and maintain communications at frequencies greater than about 100 GHz via a RIS in accordance with some embodiments.

FIG. 12 is a side view showing how an illustrative RIS may relay communications between a wireless access point and a user equipment device using different signal beams as the user equipment device moves in accordance with some embodiments.

FIG. 13 is a flow chart of illustrative operations that may be performed by a wireless access point during discovery of an optimal signal beam for a RIS by a user equipment device in accordance with some embodiments.

FIG. 14 is a flow chart of illustrative operations that may be performed by a RIS during discovery of an optimal signal beam for the RIS by a user equipment device in accordance with some embodiments.

FIG. 15 is a flow chart of illustrative operations that may be performed by a user equipment device to discover an optimal signal beam for a RIS in accordance with some embodiments.

FIG. 16 is a timing diagram showing how timing of a RIS may be unsynchronized with respect to timing of a user equipment device in accordance with some embodiments.

FIG. 17 is a timing diagram showing how an illustrative wireless access point, user equipment device, and RIS may perform multiple stages of signal beam sweeps during discovery of an optimal signal beam for the RIS by the user equipment device in accordance with some embodiments.

FIG. 18 is a timing diagram showing how an illustrative user equipment device may sweep over its own signal beams for each step in a signal beam sweep of a RIS during discovery of an optimal signal beam for the RIS in accordance with some embodiments.

FIG. 19 is a flow chart of illustrative operations that may be performed by a user equipment device to control the number of beam sweeps performed by a RIS during discovery of an optimal signal beam for the RIS in accordance with some embodiments.

### DETAILED DESCRIPTION

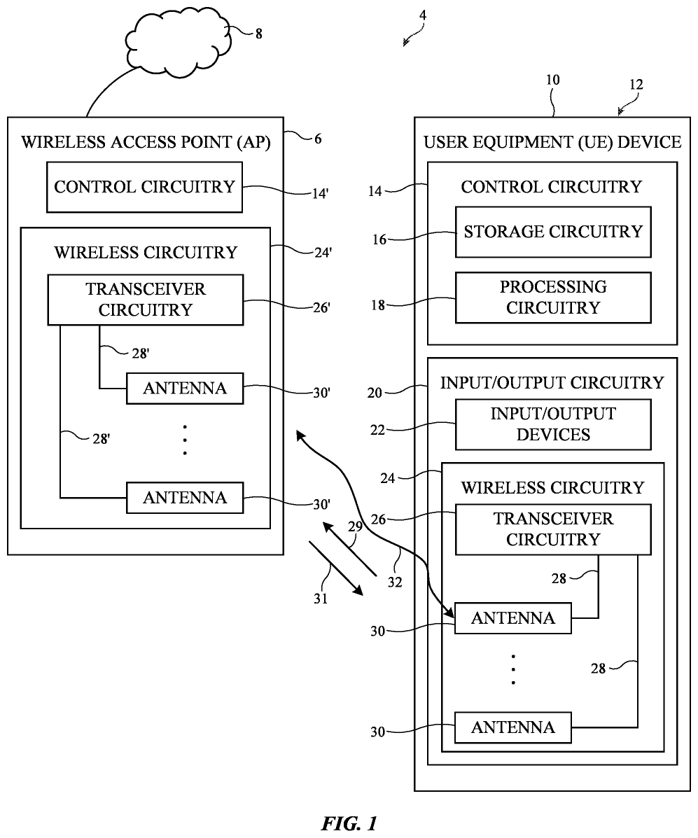

FIG. 1 is a schematic diagram of an illustrative communications system 4 (sometimes referred to herein as communications network 4) for conveying wireless data between communications terminals. Communications system 4 may include network nodes (e.g., communications terminals). The network nodes may include user equipment (UE) such as one or more UE devices 10. The network nodes may also include external communications equipment (e.g., communications equipment other than UE devices 10) such as external communications equipment 6. External communications equipment 6 may include one or more electronic devices and may be a wireless base station, wireless access point, or other wireless equipment for example. Implementations in which external communications equipment 6 is a wireless access point are described herein as an example. External communications equipment 6 may therefore sometimes be referred to herein as wireless access point 6 or simply as access point (AP) 6. UE devices 10 and AP 6 may communicate with each other using one or more wireless communications links. If desired, UE devices 10 may wirelessly communicate with AP 6 without passing communications through any other intervening network nodes in communications system 4 (e.g., UE devices 10 may communicate directly with AP 6 over-the-air).

AP 6 may be communicably coupled to a larger communications network 8 via wired and/or wireless links. The larger communications network may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. The larger communications network may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE devices 10 may send data to and/or may receive data from other nodes or terminals in the larger communications network via AP 6 (e.g., AP 6 may serve as an interface between user equipment devices 10 and the rest of the larger communications network).

User equipment (UE) device 10 of FIG. 1 is an electronic device (sometimes referred to herein as electronic device 10, device 10, or electro-optical device 10) and may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, UE device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

UE device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors, microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

UE device 10 may include input-output circuitry 20. Input-output circuitry 20 may include input-output devices 22. Input-output devices 22 may be used to allow data to be supplied to UE device 10 and to allow data to be provided from UE device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 22 may be peripherals that are coupled to a main processing unit or other portion of UE device 10 via a wired or wireless link).

Input-output circuitry 20 may include wireless circuitry 24 to support wireless communications. Wireless circuitry 24 (sometimes referred to herein as wireless communications circuitry 24) may include one or more antennas 30.

Wireless circuitry 24 may also include transceiver circuitry 26. Transceiver circuitry 26 may include transmitter circuitry, receiver circuitry, modulator circuitry, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

The example of FIG. 1 is merely illustrative. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28. Each signal path 28 may include one or more radio-frequency transmission lines, waveguides, optical fibers, and/or any other desired lines/paths for conveying wireless signals between transceiver circuitry 26 and antenna 30. Antennas 30 may be formed using any desired antenna structures for conveying wireless signals. For example, antennas 30 may include antennas with resonating elements that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna or an array of antenna elements) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc. The sensing operations may, for example, involve the transmission of sensing signals (e.g., radar waveforms), the receipt of corresponding reflected signals (e.g., the transmitted waveforms that have reflected off of external objects), and the processing of the transmitted signals and the received reflected signals (e.g., using a radar scheme).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands, etc.), other centimeter or millimeter wave frequency bands between 10-100 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-100 Gbps or higher, wireless circuitry 24 may convey wireless signals at frequencies greater than about 100 GHz.

As shown in FIG. 1, wireless circuitry 24 may transmit wireless signals 32 and/or may receive wireless signals 32 at frequencies greater than around 100 GHz (e.g., greater than 70 GHz, 80 GHz, 90 GHz, 110 GHz, etc.). Wireless signals 32 may sometimes be referred to herein as tremendously high frequency (THF) signals 32, sub-THz signals 32, THz signals 32, or sub-millimeter wave signals 32. THF signals 32 may be at sub-THz or THz frequencies such as frequencies between 100 GHz and 1 THz, between 80 GHz and 10 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 6G frequency band). The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

Space is at a premium within electronic devices such as device 10. In some scenarios, different antennas 30 are used to transmit THF signals 32 than are used to receive THF signals 32. However, handling transmission of THF signals 32 and reception of THF signals 32 using different antennas 30 can consume an excessive amount of space and other resources within device 10 because two antennas 30 and signal paths 28 would be required to handle both transmission and reception. To minimize space and resource consumption within device 10, the same antenna 30 and signal path 28 may be used to both transmit THF signals 32 and to receive THF signals 32. If desired, multiple antennas 30 in wireless circuitry 24 may transmit THF signals 32 and may receive THF signals 32. The antennas may be integrated into a phased antenna array that transmits THF signals 32 and that receives THF signals 32 within a corresponding signal beam oriented in a selected beam pointing direction.

As shown in FIG. 1, AP 6 may also include control circuitry 14′ (e.g., control circuitry having similar components and/or functionality as control circuitry 14 in UE device 10) and wireless circuitry 24′ (e.g., wireless circuitry having similar components and/or functionality as wireless circuitry 24′ in UE device 10). Wireless circuitry 24′ may include transceiver circuitry 26′ (e.g., transceiver circuitry having similar components and/or functionality as transceiver circuitry 26 in UE device 10) coupled to two or more antennas 30′ (e.g., antennas having similar components and/or functionality as antennas 30 in UE device 10) over corresponding signal paths 28′ (e.g., signal paths having similar components and/or functionality as signal paths 28 in UE device 10). Antennas 30′ may be arranged in one or more phased antenna arrays. AP 6 may use wireless circuitry 24′ to transmit THF signals 32 to UE device 10 (e.g., as downlink (DL) signals transmitted in downlink direction 31) and/or to receive THF signals 32 transmitted by UE device 10 (e.g., as uplink (UL) signals transmitted in uplink direction 29).

It can be challenging to incorporate components into wireless circuitry 24 and 24′ that support wireless communications at these high frequencies. If desired, transceiver circuitry 26 and 26′ and signal paths 28 and 28′ may include optical components that convey optical signals to support the transmission and reception of THF signals 32 in a space and resource-efficient manner. The optical signals may be used in transmitting THF signals 32 at THF frequencies and/or in receiving THF signals 32 at THF frequencies.

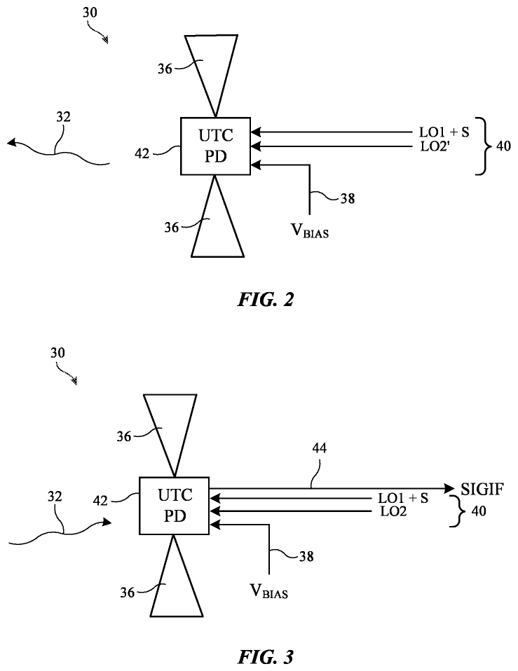

FIG. 2 is a diagram of an illustrative antenna 30 that may be used to both transmit THF signals 32 and to receive THF signals 32 in examples where AP 6 is an electro-optical device that conveys THF signals 32 using optical signals. This is illustrative and non-limiting. More particularly, FIGS. 2-7 illustrate one exemplary implementation for how antenna 30 (or antenna 30′ in AP 6) may convey THF signals 32 using optical signals (e.g., in an example where UE device 10 and/or AP 6 are electro-optical devices). This is illustrative and, in general, UE device 10 and AP 6 may generate and convey THF signals using any desired array architecture(s) (e.g., where antenna 30 is fed using one or more transmission lines and one or more phase and magnitude controllers). AP 6 and UE device 10 need not be electro-optical devices. Antenna 30 may include one or more antenna radiating (resonating) elements 36 such as radiating (resonating) element arms. In the example of FIG. 2, antenna 30 is a planar dipole antenna (sometimes referred to as a “bowtie” antenna) having an antenna resonating element 36 with two opposing resonating element arms (e.g., bowtie arms or dipole arms). This is illustrative and, in general, antenna 30 may be any type of antenna having any desired antenna radiating element architecture.

As shown in FIG. 2 (e.g., in implementations where UE device 10 or AP 6 is an electro-optical device), antenna 30 includes a photodiode (PD) 42 coupled between the arms of antenna resonating element 36. Electronic devices that include antennas 30 with photodiodes 42 such as device 10 may sometimes also be referred to as electro-optical devices. Photodiode 42 may be a programmable photodiode. An example in which photodiode 42 is a programmable uni-travelling-carrier photodiode (UTC PD) is described herein as an example. Photodiode 42 may therefore sometimes be referred to herein as UTC PD 42 or programmable UTC PD 42. This is illustrative and, in general, photodiode 42 may include any desired type of adjustable/programmable photodiode or component that converts electromagnetic energy at optical frequencies to current at THF frequencies on antenna resonating element 36 and/or vice versa (e.g., a p-i-n diode, a tunneling diode, a TW UTC photodiode, other diodes with quadratic characteristics, an LT-GaAS photodiode, an M-UTC photodiode, etc.). Each radiating element arm in antenna resonating element 36 may, for example, have a first edge at UTC PD 42 and a second edge opposite the first edge that is wider than the first edge (e.g., in implementations where antenna 30 is a bowtie antenna). Other radiating elements may be used if desired.

UTC PD 42 may have a bias terminal (input) 38 that receives one or more control signals V_{BIAS}. Control signals V_{BIAS} may include bias voltages provided at one or more voltage levels and/or other control signals for controlling the operation of UTC PD 42 such as impedance adjustment control signals for adjusting the output impedance of UTC PD 42. Control circuitry 14 (FIG. 1) may provide (e.g., apply, supply, assert, etc.) control signals V_{BIAS} at different settings (e.g., values, magnitudes, etc.) to dynamically control (e.g., program or adjust) the operation of UTC PD 42 over time. For example, control signals V_{BIAS} may be used to control whether antenna 30 transmits THF signals 32 or receives THF signals 32. When control signals V_{BIAS} include a bias voltage asserted at a first level or magnitude, antenna 30 may be configured to transmit THF signals 32. When control signals V_{BIAS} include a bias voltage asserted at a second level or magnitude, antenna 30 may be configured to receive THF signals 32. In the example of FIG. 2, control signals V_{BIAS} include the bias voltage asserted at the first level to configure antenna 30 to transmit THF signals 32. If desired, control signals V_{BIAS} may also be adjusted to control the waveform of the THF signals (e.g., as a squaring function that preserves the modulation of incident optical signals, a linear function, etc.), to perform gain control on the signals conveyed by antenna 30, and/or to adjust the output impedance of UTC PD 42.

As shown in FIG. 2 (e.g., in implementations where UE device 10 or AP 6 is an electro-optical device), UTC PD 42 may be optically coupled to optical path 40. Optical path 40 may include one or more optical fibers or waveguides. UTC PD 42 may receive optical signals from transceiver circuitry 26 (FIG. 1) over optical path 40. The optical signals may include a first optical local oscillator (LO) signal LO1 and a second optical local oscillator signal LO2. Optical local oscillator signals LO1 and LO2 may be generated by light sources in transceiver circuitry 26 (FIG. 1). Optical local oscillator signals LO1 and LO2 may be at optical wavelengths (e.g., between 400 nm and 700 nm), ultra-violet wavelengths (e.g., near-ultra-violet or extreme ultraviolet wavelengths), and/or infrared wavelengths (e.g., near-infrared wavelengths, mid-infrared wavelengths, or far-infrared wavelengths). Optical local oscillator signal LO2 may be offset in wavelength from optical local oscillator signal LO1 by a wavelength offset X. Wavelength offset X may be equal to the wavelength of the THF signals conveyed by antenna 30 (e.g., between 100 GHz and 1 THz (1000 GHz), between 100 GHz and 2 THz, between 300 GHz and 800 GHz, between 300 GHz and 1 THz, between 300 and 400 GHz, etc.).

During signal transmission, wireless data (e.g., wireless data packets, symbols, frames, etc.) may be modulated onto optical local oscillator signal LO2 to produce modulated optical local oscillator signal LO2′. If desired, optical local oscillator signal LO1 may be provided with an optical phase shift S. Optical path 40 may illuminate UTC PD 42 with optical local oscillator signal LO1 (plus the optical phase shift S when applied) and modulated optical local oscillator signal LO2′. If desired, lenses or other optical components may be interposed between optical path 40 and UTC PD 42 to help focus the optical local oscillator signals onto UTC PD 42.

UTC PD 42 may convert optical local oscillator signal LO1 and modulated local oscillator signal LO2′ (e.g., beats between the two optical local oscillator signals) into antenna currents that run along the perimeter of the radiating element arms in antenna resonating element 36. The frequency of the antenna current is equal to the frequency difference between local oscillator signal LO1 and modulated local oscillator signal LO2′. The antenna currents may radiate (transmit) THF signals 32 into free space. Control signal V_{BIAS} may control UTC PD 42 to convert the optical local oscillator signals into antenna currents on the radiating element arms in antenna resonating element 36 while preserving the modulation and thus the wireless data on modulated local oscillator signal LO2′ (e.g., by applying a squaring function to the signals). THF signals 32 will thereby carry the modulated wireless data for reception and demodulation by external wireless communications equipment.

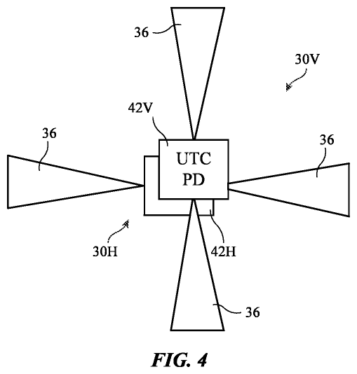

FIG. 3 is a diagram showing how antenna 30 may receive THF signals 32 (e.g., after changing the setting of control signals V_{BIAS} into a reception state from the transmission state of FIG. 2, in implementations where UE device 10 or AP 6 is an electro-optical device). As shown in FIG. 3, THF signals 32 may be incident upon the antenna radiating element arms of antenna resonating element 36. The incident THF signals 32 may produce antenna currents that flow around the perimeter of the radiating element arms in antenna resonating element 36. UTC PD 42 may use optical local oscillator signal LO1 (plus the optical phase shift S when applied), optical local oscillator signal LO2 (e.g., without modulation), and control signals V_{BIAS} (e.g., a bias voltage asserted at the second level) to convert the received THF signals 32 into intermediate frequency signals SIGIF that are output onto intermediate frequency signal path 44.

The frequency of intermediate frequency signals SIGIF may be equal to the frequency of THF signals 32 minus the difference between the frequency of optical local oscillator signal LO1 and the frequency of optical local oscillator signal LO2. As an example, intermediate frequency signals SIGIF may be at lower frequencies than THF signals such as centimeter or millimeter wave frequencies between 10 GHz and 100 GHz, between 30 GHz and 80 GHz, around 60 GHz, etc. If desired, transceiver circuitry 26 (FIG. 1) may change the frequency of optical local oscillator signal LO1 and/or optical local oscillator signal LO2 when switching from transmission to reception or vice versa. UTC PD 42 may preserve the data modulation of THF signals 32 in intermediate signals SIGIF. A receiver in transceiver circuitry 26 (FIG. 1) may demodulate intermediate frequency signals SIGIF (e.g., after further downconversion) to recover the wireless data from THF signals 32. In another example, wireless circuitry 24 may convert intermediate frequency signals SIGIF to the optical domain before recovering the wireless data. In yet another example, intermediate frequency signal path 44 may be omitted and UTC PD 42 may convert THF signals 32 into the optical domain for subsequent demodulation and data recovery (e.g., in a sideband of the optical signal).

While FIGS. 2 and 3 show an illustrative antenna 30 from UE device 10, similar structures may additionally or alternatively be used to form antenna 30′ on AP 6 (e.g., where antenna 30′ conveys signals for transceiver circuitry 26′ in wireless circuitry 24′ of FIG. 1 instead of for transceiver circuitry 26 in wireless circuitry 24 as described in connection with FIGS. 2 and 3). The antenna 30 of FIGS. 2 and 3 may support transmission of THF signals 32 and reception of THF signals 32 with a given polarization (e.g., a linear polarization such as a vertical polarization). If desired, wireless circuitry 24 and/or 24′ (FIG. 1) may include multiple antennas 30 and/or 30′ for covering different polarizations. FIG. 4 is a diagram showing one example of how wireless circuitry 24 in UE device 10 may include multiple antennas 30 for covering different polarizations. While FIG. 4 shows illustrative antennas 30 from UE device 10, similar structures may additionally or alternatively be used to form antenna 30′ on AP 6.

As shown in FIG. 4, the wireless circuitry may include a first antenna 30 such as antenna 30V for covering a first polarization (e.g., a first linear polarization such as a vertical polarization) and may include a second antenna 30 such as antenna 30H for covering a second polarization different from or orthogonal to the first polarization (e.g., a second linear polarization such as a horizontal polarization). Antenna 30V may have a UTC PD 42 such as UTC PD 42V coupled between a corresponding pair of radiating element arms in antenna resonating element 36. Antenna 30H may have a UTC PD 42 such as UTC PD 42H coupled between a corresponding pair of radiating element arms in antenna resonating element 36 oriented non-parallel (e.g., orthogonal) to the radiating element arms in antenna resonating element 36 of antenna 30V. This may allow antennas 30V and 30H to transmit THF signals 32 with respective (orthogonal) polarizations and may allow antennas 30V and 30H to receive THF signals 32 with respective (orthogonal) polarizations.

To minimize space within device 10, antenna 30V may be vertically stacked over or under antenna 30H (e.g., where UTC PD 42V partially or completely overlaps UTC PD 42H). In this example, antennas 30V and 30H may both be formed on the same substrate such as a rigid or flexible printed circuit board. The substrate may include multiple stacked dielectric layers (e.g., layers of ceramic, epoxy, flexible printed circuit board material, rigid printed circuit board material, etc.). The antenna resonating element 36 in antenna 30V may be formed on a separate layer of the substrate than the antenna resonating element 36 in antenna 30H or the antenna resonating element 36 in antenna 30V may be formed on the same layer of the substrate as the antenna resonating element 36 in antenna 30H. UTC PD 42V may be formed on the same layer of the substrate as UTC PD 42H or UTC PD 42V may be formed on a separate layer of the substrate than UTC PD 42H. UTC PD 42V may be formed on the same layer of the substrate as the antenna resonating element 36 in antenna 30V or may be formed on a separate layer of the substrate as the antenna resonating element 36 in antenna 30V. UTC PD 42H may be formed on the same layer of the substrate as the antenna resonating element 36 in antenna 30H or may be formed on a separate layer of the substrate as the antenna resonating element 36 in antenna 30H.

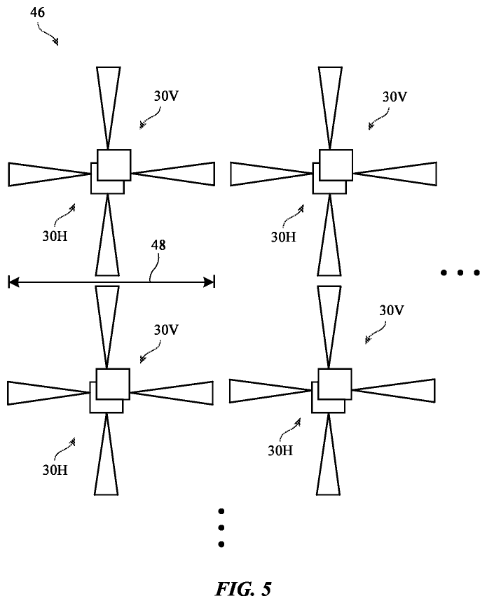

If desired, antennas 30 or antennas 30H and 30V of FIG. 4 may be integrated within a phased antenna array. FIG. 5 is a diagram showing one example of how antennas 30H and 30V may be integrated within a phased antenna array. As shown in FIG. 5, UE device 10 may include a phased antenna array 46 of stacked antennas 30H and 30V arranged in a rectangular grid of rows and columns. Each of the antennas in phased antenna array 46 may be formed on the same substrate. This is illustrative and non-limiting. In general, phased antenna array 46 may include any desired number of antennas 30V and 30H (or non-stacked antennas 30) arranged in any desired pattern. Each of the antennas in phased antenna array 46 may be provided with a respective optical phase shift S (FIGS. 2 and 3) that configures the antennas to collectively transmit THF signals 32 and/or receive THF signals 32 that sum to form a signal beam of THF signals in a desired beam pointing direction. The beam pointing direction may be selected to point the signal beam towards external communications equipment, towards a desired external object, away from an external object, etc. Phased antenna array 46 may also sometimes be referred to herein as an array of antenna elements (e.g., where each antenna 30V and each antenna 30H or the antenna radiating elements thereof forms a respective antenna element in the array of antenna elements).

Phased antenna array 46 may occupy relatively little space within device 10. For example, each antenna 30V/30H may have a length 48 (e.g., as measured from the end of one radiating element arm to the opposing end of the opposite radiating element arm). Length 48 may be approximately equal to one-half the wavelength of THF signals 32. For example, length 48 may be as small as 0.5 mm or less. Each UTC-PD 42 in phased antenna array 46 may occupy a lateral area of 100 square microns or less. This may allow phased antenna array 46 to occupy very little area within UE device 10, thereby allowing the phased antenna array to be integrated within different portions of device 10 while still allowing other space for device components. While FIG. 5 shows an illustrative phased antenna array that may be formed in UE device 10, similar structures may additionally or alternatively be used to form a phased antenna array on AP 6 (e.g., using antennas 30′ of FIG. 1). The examples of FIGS. 2-5 are illustrative and, in general, each antenna may have any desired antenna radiating element architecture.

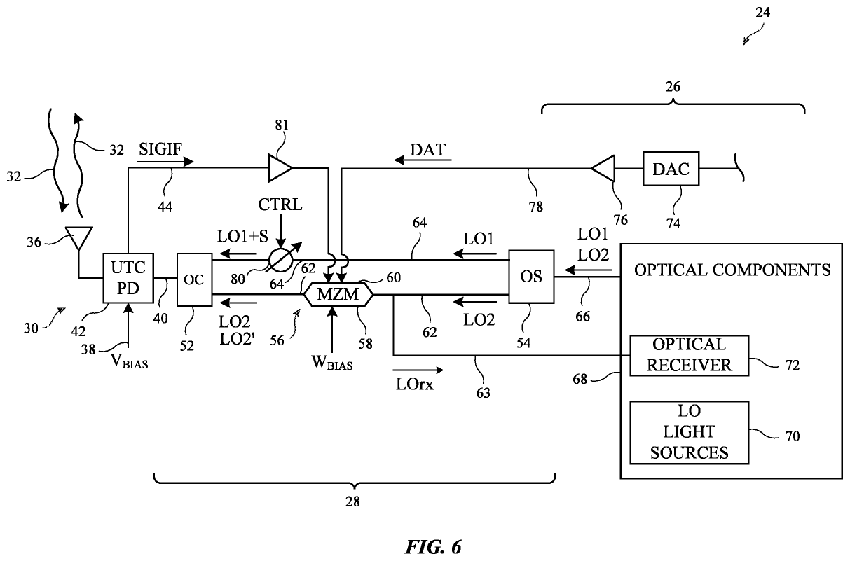

FIG. 6 is a circuit diagram showing how a given antenna 30, signal path 28, and transceiver circuitry 26 may be used to both transmit THF signals 32 and receive THF signals 32 based on optical local oscillator signals. While FIG. 6 illustrates an antenna 30, signal path 28, and transceiver circuitry 26 from UE device 10, similar structures may additionally or alternatively be used to form antenna 30′, signal path 28′, and transceiver circuitry 26, respectively, on AP 6 (FIG. 1). In the example of FIG. 6, UTC PD 42 converts received THF signals 32 into intermediate frequency signals SIGIF that are then converted to the optical domain for recovering the wireless data from the received THF signals.

As shown in FIG. 6, wireless circuitry 24 may include transceiver circuitry 26 coupled to antenna 30 over signal path 28 (e.g., an optical signal path sometimes referred to herein as optical signal path 28). UTC PD 42 may be coupled between the radiating element arm(s) in antenna resonating element 36 of antenna 30 and signal path 28. Transceiver circuitry 26 may include optical components 68, amplifier circuitry such as power amplifier 76, and digital-to-analog converter (DAC) 74. Optical components 68 may include an optical receiver such as optical receiver 72 and optical local oscillator (LO) light sources (emitters) 70. LO light sources 70 may include two or more light sources such as laser light sources, laser diodes, optical phase locked loops, or other optical emitters that emit light (e.g., optical local oscillator signals LO1 and LO2) at respective wavelengths. If desired, LO light sources 70 may include a single light source and may include optical components for splitting the light emitted by the light source into different wavelengths. Signal path 28 may be coupled to optical components 68 over optical path 66. Optical path 66 may include one or more optical fibers and/or waveguides.

Signal path 28 may include an optical splitter such as optical splitter (OS) 54, optical paths such as optical path 64 and optical path 62, an optical combiner such as optical combiner (OC) 52, and optical path 40. Optical path 62 may be an optical fiber or waveguide. Optical path 64 may be an optical fiber or waveguide. Optical splitter 54 may have a first (e.g., input) port coupled to optical path 66, a second (e.g., output) port coupled to optical path 62, and a third (e.g., output) port coupled to optical path 64. Optical path 64 may couple optical splitter 54 to a first (e.g., input) port of optical combiner 52. Optical path 62 may couple optical splitter 54 to a second (e.g., input) port of optical combiner 52. Optical combiner 52 may have a third (e.g., output) port coupled to optical path 40.

An optical phase shifter such as optical phase shifter 80 may be (optically) interposed on or along optical path 64. An optical modulator such as optical modulator 56 may be (optically) interposed on or along optical path 62. Optical modulator 56 may be, for example, a Mach-Zehnder modulator (MZM) and may therefore sometimes be referred to herein as MZM 56. MZM 56 includes a first optical arm (branch) 60 and a second optical arm (branch) 58 interposed in parallel along optical path 62. Propagating optical local oscillator signal LO2 along arms 60 and 58 of MZM 56 may, in the presence of a voltage signal applied to one or both arms, allow different optical phase shifts to be imparted on each arm before recombining the signal at the output of the MZM (e.g., where optical phase modulations produced on the arms are converted to intensity modulations at the output of MZM 56). When the voltage applied to MZM 56 includes wireless data, MZM 56 may modulate the wireless data onto optical local oscillator signal LO2. If desired, the phase shifting performed at MZM 56 may be used to perform beam forming/steering in addition to or instead of optical phase shifter 80. MZM 56 may receive one or more bias voltages W_{BIAS} (sometimes referred to herein as bias signals W_{BIAS}) applied to one or both of arms 58 and 60. Control circuitry 14 (FIG. 1) may provide bias voltage W_{BIAS} with different magnitudes to place MZM 56 into different operating modes (e.g., operating modes that suppress optical carrier signals, operating modes that do not suppress optical carrier signals, etc.).

Intermediate frequency signal path 44 may couple UTC PD 42 to MZM 56 (e.g., arm 60). An amplifier such as low noise amplifier 81 may be interposed on intermediate frequency signal path 44. Intermediate frequency signal path 44 may be used to pass intermediate frequency signals SIGIF from UTC PD 42 to MZM 56. DAC 74 may have an input coupled to up-conversion circuitry, modulator circuitry, and/or baseband circuitry in a transmitter of transceiver circuitry 26. DAC 74 may receive digital data to transmit over antenna 30 and may convert the digital data to the analog domain (e.g., as data DAT). DAC 74 may have an output coupled to transmit data path 78. Transmit data path 78 may couple DAC 74 to MZM 56 (e.g., arm 60). Each of the components along signal path 28 may allow the same antenna 30 to both transmit THF signals 32 and receive THF signals 32 (e.g., using the same components along signal path 28), thereby minimizing space and resource consumption within device 10.

LO light sources 70 may produce (emit) optical local oscillator signals LO1 and LO2 (e.g., at different wavelengths that are separated by the wavelength of THF signals 32). Optical components 68 may include lenses, waveguides, optical couplers, optical fibers, and/or other optical components that direct the emitted optical local oscillator signals LO1 and LO2 towards optical splitter 54 via optical path 66. Optical splitter 54 may split the optical signals on optical path 66 (e.g., by wavelength) to output optical local oscillator signal LO1 onto optical path 64 while outputting optical local oscillator signal LO2 onto optical path 62.

Control circuitry may provide phase control signals CTRL to optical phase shifter 80. Phase control signals CTRL may control optical phase shifter 80 to apply optical phase shift S to the optical local oscillator signal LO1 on optical path 64. Phase shift S may be selected to steer a signal beam of THF signals 32 in a desired pointing direction. Optical phase shifter 80 may pass the phase-shifted optical local oscillator signal LO1 (denoted as LO1+S) to optical combiner 52. Signal beam steering is performed in the optical domain (e.g., using optical phase shifter 80) rather than in the THF domain because there are no satisfactory phase shifting circuit components that operate at frequencies as high as the frequencies of THF signals 32. Optical combiner 52 may receive optical local oscillator signal LO2 over optical path 62. Optical combiner 52 may combine optical local oscillator signals LO1 and LO2 onto optical path 40, which directs the optical local oscillator signals onto UTC PD 42 for use during signal transmission or reception.

During transmission of THF signals 32, DAC 74 may receive digital wireless data (e.g., data packets, frames, symbols, etc.) for transmission over THF signals 32. DAC 74 may convert the digital wireless data to the analog domain and may output (transmit) the data onto transmit data path 78 as data DAT (e.g., for transmission via antenna 30). Power amplifier 76 may amplify data DAT. Transmit data path 78 may pass data DAT to MZM 56 (e.g., arm 60). MZM 56 may modulate data DAT onto optical local oscillator signal LO2 to produce modulated optical local oscillator signal LO2′ (e.g., an optical local oscillator signal at the frequency/wavelength of optical local oscillator signal LO2 but that is modulated to include the data identified by data DAT). Optical combiner 52 may combine optical local oscillator signal LO1 with modulated optical local oscillator signal LO2′ at optical path 40.

Optical path 40 may illuminate UTC PD 42 with (using) optical local oscillator signal LO1 (e.g., with the phase shift S applied by optical phase shifter 80) and modulated optical local oscillator signal LO2′. Control circuitry may apply a control signal V_{BIAS} to UTC PD 42 that configures antenna 30 for the transmission of THF signals 32. UTC PD 42 may convert optical local oscillator signal LO1 and modulated optical local oscillator signal LO2′ into antenna currents on antenna resonating element 36 at the frequency of THF signals 32 (e.g., while programmed for transmission using control signal V_{BIAS}). The antenna currents on antenna resonating element 36 may radiate THF signals 32. The frequency of THF signals 32 is given by the difference in frequency between optical local oscillator signal LO1 and modulated optical local oscillator signal LO2′. Control signals V_{BIAS} may control UTC PD 42 to preserve the modulation from modulated optical local oscillator signal LO2′ in the radiated THF signals 32. External equipment that receives THF signals 32 will thereby be able to extract data DAT from the THF signals 32 transmitted by antenna 30.

During reception of THF signals 32, MZM 56 does not modulate any data onto optical local oscillator signal LO2. Optical path 40 therefore illuminates UTC PD 42 with optical local oscillator signal LO1 (e.g., with phase shift S) and optical local oscillator signal LO2. Control circuitry may apply a control signal V_{BIAS} (e.g., a bias voltage) to UTC PD 42 that configures antenna 30 for the receipt of THF signals 32. UTC PD 42 may use optical local oscillator signals LO1 and LO2 to convert the received THF signals 32 into intermediate frequency signals SIGIF output onto intermediate frequency signal path 44 (e.g., while programmed for reception using bias voltage V_{BIAS}). Intermediate frequency signals SIGIF may include the modulated data from the received THF signals 32. Low noise amplifier 81 may amplify intermediate frequency signals SIGIF, which are then provided to MZM 56 (e.g., arm 60). MZM 56 may convert intermediate frequency signals SIGIF to the optical domain as optical signals LOrx (e.g., by modulating the data in intermediate frequency signals SIGIF onto one of the optical local oscillator signals) and may pass the optical signals to optical receiver 72 in optical components 68, as shown by arrow 63 (e.g., via optical paths 62 and 66 or other optical paths). Control circuitry may use optical receiver 72 to convert optical signals LOrx to other formats and to recover (demodulate) the data carried by THF signals 32 from the optical signals. In this way, the same antenna 30 and signal path 28 may be used for both the transmission and reception of THF signals while also performing beam steering operations.

The example of FIG. 6 in which intermediate frequency signals SIGIF are converted to the optical domain is illustrative and non-limiting. If desired, transceiver circuitry 26 may receive and demodulate intermediate frequency signals SIGIF without first passing the signals to the optical domain. For example, transceiver circuitry 26 may include an analog-to-digital converter (ADC), intermediate frequency signal path 44 may be coupled to an input of the ADC rather than to MZM 56, and the ADC may convert intermediate frequency signals SIGIF to the digital domain. As another example, intermediate frequency signal path 44 may be omitted and control signals V_{BIAS} may control UTC PD 42 to directly sample THF signals 32 with optical local oscillator signals LO1 and LO2 to the optical domain. As an example, UTC PD 42 may use the received THF signals 32 and control signals V_{BIAS} to produce an optical signal on optical path 40. The optical signal may have an optical carrier with sidebands that are separated from the optical carrier by a fixed frequency offset (e.g., 30-100 GHz, 60 GHz, 50-70 GHz, 10-100 GHz, etc.). The sidebands may be used to carry the modulated data from the received THF signals 32. Signal path 28 may direct (propagate) the optical signal produced by UTC PD 42 to optical receiver 72 in optical components 68 (e.g., via optical paths 40, 64, 62, 66, 63, and/or other optical paths). Control circuitry may use optical receiver 72 to convert the optical signal to other formats and to recover (demodulate) the data carried by THF signals 32 from the optical signal (e.g., from the sidebands of the optical signal).

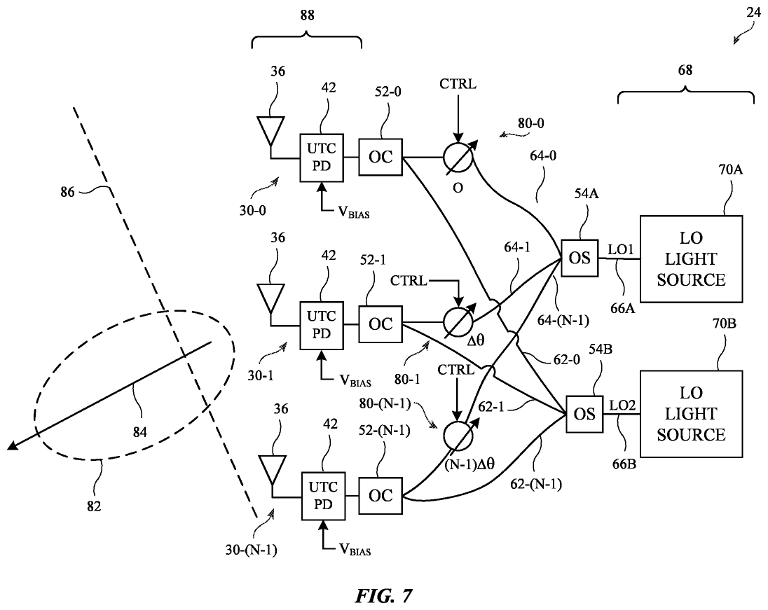

FIG. 7 is a circuit diagram showing one example of how multiple antennas 30 may be integrated into a phased antenna array 88 that conveys THF signals over a corresponding signal beam (e.g., in examples where UE device 10 and/or AP 6 are electro-optical or photonic devices). The example of FIG. 7 is illustrative and, in general, phased antenna array 88 may be implemented using any desired array architecture (e.g., phased antenna array 88 need not use optical signals for conveying THF signals 32 and, in general, may include a set of antennas 30/30′ coupled to any respective phase and/or magnitude controllers that are used for performing the beamforming operations as described herein). In the example of FIG. 7, MZMs 56, intermediate frequency signal paths 44, data paths 78, and optical receiver 72 of FIG. 6 have been omitted for the sake of clarity. Each of the antennas in phased antenna array 88 may alternatively sample received THF signals directly into the optical domain or may pass intermediate frequency signals SIGIF to ADCs in transceiver circuitry 26.

As shown in FIG. 7, phased antenna array 88 includes N antennas 30 such as a first antenna 30-0, a second antenna 30-1, an Nth antenna 30-(N−1), etc. Each of the antennas 30 in phased antenna array 88 may be coupled to optical components 68 via a respective optical signal path (e.g., optical signal path 28 of FIG. 6). Each of the N signal paths may include a respective optical combiner 52 coupled to the UTC PD 42 of the corresponding antenna 30 (e.g., the UTC PD 42 in antenna 30-0 may be coupled to optical combiner 52-0, the UTC PD 42 in antenna 30-1 may be coupled to optical combiner 52-1, the UTC PD 42 in antenna 30-(N−1) may be coupled to optical combiner 52-(N−1), etc.). Each of the N signal paths may also include a respective optical path 62 and a respective optical path 64 coupled to the corresponding optical combiner 52 (e.g., optical paths 64-0 and 62-0 may be coupled to optical combiner 52-0, optical paths 64-1 and 62-1 may be coupled to optical combiner 52-1, optical paths 64-(N−1) and 62-(N−1) may be coupled to optical combiner 52-(N−1), etc.).

Optical components 68 may include LO light sources 70 such as a first LO light source 70A and a second LO light source 70B. The optical signal paths for each of the antennas 30 in phased antenna array 88 may share one or more optical splitters 54 such as a first optical splitter 54A and a second optical splitter 54B. LO light source 70A may generate (e.g., produce, emit, transmit, etc.) first optical local oscillator signal LO1 and may provide first optical local oscillator signal LO1 to optical splitter 54A via optical path 66A. Optical splitter 54A may distribute first optical local oscillator signal LO1 to each of the UTC PDs 42 in phased antenna array 88 over optical paths 64 (e.g., optical paths 64-0, 64-1, 64-(N−1), etc.). Similarly, LO light source 70B may generate (e.g., produce, emit, transmit, etc.) second optical local oscillator signal LO2 and may provide second optical local oscillator signal LO2 to optical splitter 54B via optical path 66B. Optical splitter 54B may distribute second optical local oscillator signal LO2 to each of the UTC PDs 42 in phased antenna array 88 over optical paths 62 (e.g., optical paths 62-0, 62-1, 62-(N−1), etc.).

A respective optical phase shifter 80 may be interposed along (on) each optical path 64 (e.g., a first optical phase shifter 80-0 may be interposed along optical path 64-0, a second optical phase shifter 80-1 may be interposed along optical path 64-1, an Nth optical phase shifter 80-(N−1) may be interposed along optical path 64-(N−1), etc.). Each optical phase shifter 80 may receive a control signal CTRL that controls the phase S provided to optical local oscillator signal LO1 by that optical phase shifter (e.g., first optical phase shifter 80-0 may impart an optical phase shift of zero degrees/radians to the optical local oscillator signal LO1 provided to antenna 30-0, second optical phase shifter 80-1 may impart an optical phase shift of Δϕ to the optical local oscillator signal LO1 provided to antenna 30-1, Nth optical phase shifter 80-(N−1) may impart an optical phase shift of (N−1)Δϕ to the optical local oscillator signal LO1 provided to antenna 30-(N−1), etc.). By adjusting the phase S imparted by each of the N optical phase shifters 80, control circuitry 14 (FIG. 1) may control each of the antennas 30 in phased antenna array 88 to transmit THF signals 32 and/or to receive THF signals 32 within a formed signal beam 82. Signal beam 82 may be oriented in a particular beam pointing direction (angle) 84 (e.g., the direction of peak gain of signal beam 82). The THF signals conveyed by phased antenna array 88 may have wavefronts 86 that are orthogonal to beam pointing direction 84. Control circuitry 14 may adjust beam pointing direction 84 over time to point towards external communications equipment or an external object or to point away from external objects, as examples. While FIG. 7 shows an illustrative phased antenna array 88 of antennas 30 from UE device 10, similar structures may additionally or alternatively be used to form a phased antenna array of antennas 30′ in AP 6 (sometimes referred to herein as phased antenna array 88′).

While communications at frequencies greater than about 100 GHz allow for extremely high data rates (e.g., greater than 100 Gbps), radio-frequency signals at such high frequencies are subject to significant attenuation during propagation over-the-air. Integrating antennas 30 and 30′ into phased antenna arrays helps to counteract this attenuation by boosting the gain of the signals in producing signal beam 82. However, signal beam 82 is highly directive and may require a line-of-sight (LOS) between UE device 10 and AP 6. If an external object is present between AP 6 and UE device 10, the external object may block the LOS between UE device 10 and AP 6, which can disrupt wireless communications using THF signals 32. If desired, a reconfigurable intelligent surface (RIS) may be used to allow UE device 10 and AP 6 to continue to communicate using THF signals 32 even when an external object blocks the LOS between UE device 10 and AP 6.

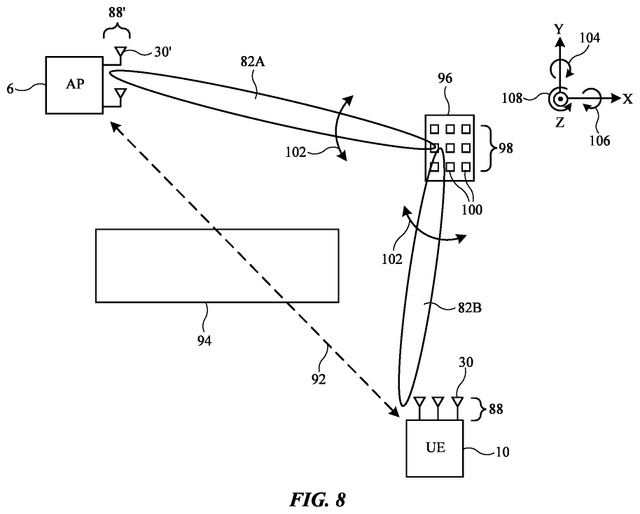

FIG. 8 is a diagram of an exemplary environment 90 in which a reconfigurable intelligent surface (RIS) is used to allow UE device 10 and AP 6 to continue to communicate using THF signals 32 despite the presence of an external object in the LOS between UE device 10 and AP 6. As shown in FIG. 8, AP 6 may be at a first location in environment 90 and UE device 10 may be at a second location in environment 90. AP 6 may be separated from UE device 10 by LOS path 92. In some circumstances, an external object such as object 94 may block LOS path 92. Object 94 may be, for example, furniture, a body or body part, an animal, a wall or corner of a room, a cubicle wall, a vehicle, a landscape feature, or other obstacles or objects that may block LOS path 92.

In the absence of external object 94, AP 6 may form a corresponding signal beam (e.g., signal beam 82 of FIG. 7) oriented in the direction of UE device 10 and UE device 10 may form a corresponding signal beam (e.g., signal beam 82 of FIG. 7) oriented in the direction of AP 6. The signal beam of AP 6 may, for example, overlap the signal beam of UE device 10 in the direction of LOS path 92. UE device 10 and AP 6 can then convey THF signals 32 over their respective beams and LOS path 92.

However, the presence of external object 94 prevents THF signals 32 from being conveyed over LOS path 92. RIS 96 may be placed or disposed within environment 90 to allow UE device 10 and AP 6 to exchange THF signals 32 despite the presence of external object 94 within LOS path 92. RIS 96 may also be used to reflect signals between UE device 10 and AP 6 when reflection via RIS 96 offers superior radio-frequency propagation conditions to LOS path 92 (e.g., when the LOS between AP 6 and RIS 96 and the LOS between RIS 96 and UE device 10 collectively exhibit better radio-frequency channel conditions than LOS path 92).

RIS 96 (sometimes referred to as intelligent reflective/reconfigurable surface (IRS) 96, reflective surface 96, reconfigurable surface 96, or electronic device 96) is an electronic device that includes a two-dimensional surface of engineered material having reconfigurable properties for performing communications between AP 6 and UE device 10. RIS 96 may include an array 98 of antenna elements 100 on an underlying substrate. The substrate may be a rigid or flexible printed circuit board, a package, a plastic substrate, meta-material, or any other desired substrate. The substrate may be planar or may be curved in one or more dimensions. If desired, the substrate and antenna elements 100 may be enclosed within a housing. The housing may be formed from materials that are transparent to THF signals 32. If desired, RIS 96 may be disposed (e.g., layered) onto an underlying electronic device. RIS 96 may also be provided with mounting structures (e.g., adhesive, brackets, a frame, screws, pins, clips, etc.) that can be used to affix or attach RIS 96 to an underlying structure such as another electronic device, a wall, the ceiling, the floor, furniture, etc. Disposing RIS 96 on a ceiling, wall, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing RIS 96 to reflect THF signals between AP 6 and UE 10 around various objects 94 that may be present within the room.

RIS 96 may be a powered device that includes control circuitry (e.g., one or more processors) that helps to control the operation of array 98 (e.g., control circuitry such as control circuitry 14 of FIG. 1). When electro-magnetic (EM) energy waves (e.g., waves of THF signals 32) are incident on RIS 96, the wave is effectively reflected by each antenna element 100 in array 98 (e.g., via re-radiation by each antenna element 100 with a respective phase and amplitude response). The control circuitry on RIS 96 may determine the response on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). The scattering, absorption, reflection, and diffraction properties of the entire RIS can therefore be changed over time and controlled (e.g., by software running on the RIS or other devices communicably coupled to the RIS such as AP 6 or UE device 10). One way of achieving the per-element phase and amplitude response of antenna elements 100 is by adjusting the impedance of antenna elements 100, thereby controlling the complex reflection coefficient that determines the change in amplitude and phase of the re-radiated signal. The control circuitry on RIS 96 may configure antenna elements 100 to exhibit impedances (or other properties) that serve to reflect THF signals 32 incident from particular incident angles onto particular output angles. The antenna elements (e.g., the antenna impedances) may be adjusted to change the angle with which incident THF signals 32 are reflected off of RIS 96.

For example, the control circuitry on RIS 96 may configure array 98 to reflect THF signals 32 transmitted by AP 6 towards UE device 10 and to reflect THF signals 32 transmitted by UE device 10 towards AP 6. This may effectively cause the signal beam 82 between AP 6 and UE device 10 to form a reflected signal beam having a first portion 82A from AP 6 to RIS 96 and a second portion 82B from RIS 96 to UE device 10. To convey THF signals 32 over the reflected signal beam, phased antenna array 88′ on AP 6 may perform beamforming (e.g., by configuring its antennas 30′ with respective beamforming coefficients as given by an AP codebook at AP 6) to form a signal beam of AP 6 (sometimes referred to herein as an AP signal beam or simply as an AP beam) with a beam pointing direction oriented towards RIS 96 (e.g., as shown by portion 82A of the signal beam). Similarly, phased antenna array 88 on UE device 10 may perform beamforming (e.g., by configuring its antennas 30 with respective beamforming coefficients as given by a UE codebook at UE device 10) to form a signal beam of UE device 10 (sometimes referred to herein as a UE signal beam or simply as a UE beam) with a beam pointing direction oriented towards RIS 96 (e.g., as shown by portion 82B of the signal beam).

At the same, RIS 96 may configure its own antenna elements 100 to perform beamforming with respective beamforming coefficients (e.g., as given by a RIS codebook at RIS 96). The beamforming performed at RIS 96 may include two concurrently active signal beams of RIS 96, referred to herein as RIS beams (e.g., where each RIS beam is generated using a corresponding set of beamforming coefficients). RIS 96 may form a first active RIS beam (referred to herein as a RIS-AP beam) that has a beam pointing direction oriented towards AP 6 and may concurrently form a second active RIS beam (referred to herein as a RIS-UE beam) that has a beam pointing direction oriented towards UE device 10. In this way, when THF signals 32 are incident from AP 6 (e.g., within portion 82A of the signal beam), the antenna elements on RIS 96 may receive the THF signals incident from the direction of AP 6 and may re-radiate (e.g., effectively reflect) the incident THF signals 32 towards the direction of UE device 10 (e.g., within portion 82B of the signal beam). Conversely, when THF signals 32 are incident from UE device 10 (e.g., within portion 82B of the signal beam), the antenna elements on RIS 96 may receive the THF signals incident from the direction of UE device 10 and may re-radiate (e.g., effectively reflect) the incident THF signals 32 towards the direction of AP 6 (e.g., within portion 82A of the signal beam). While referred to herein as “beams,” the RIS-UE beams and RIS-AP beams formed by RIS 96 do not include signals/data that are actively transmitted by RIS 96 but instead correspond to the impedance, phase, and/or magnitude response settings (e.g., complex reflection coefficient settings) for antenna elements 100 that shape the reflected signal beam of THF signals from a corresponding incident direction/angle onto a corresponding output direction/angle (e.g., the RIS-UE beam may be effectively formed using a first set of beamforming coefficients and the RIS-AP beam may be effectively formed using a second set of beamforming coefficients but are not associated with the active transmission of wireless signals by RIS 96).

The control circuitry on RIS 96 may set and adjust the impedances (or other characteristics) of antenna elements 100 in array 98 to reflect THF signals 32 in desired directions (e.g., using a data transfer RAT associated with communications at the frequencies of THF signals 32). The control circuitry on RIS 96 may communicate with AP 6 and/or UE device 10 using radio-frequency signals at lower frequencies using a control RAT that is different than the data transfer RAT. The control RAT may be used to help control the operation of array 98 in reflecting THF signals 32 and may be used to convey any desired control signals between AP 6, RIS 96, and UE device 10 (e.g., control signals that are separate from the wireless data conveyed between AP 6 and UE device 10 using the data transfer RAT). For example, the control RAT may allow AP 6, UE device 10, and/or RIS 96 to interact with each other before a THz link is established over the data transfer RAT, e.g., to set up, establish, and maintain the THz link with the data transfer RAT, to coordinate control procedures between AP 6 and UE device 10 such as beam sweeping or beam tracking, etc. RIS 96 may include transceiver circuitry and the control circuitry on RIS 96 may include one or more processors that handle communications using the control RAT. One or more antenna elements 100 on RIS 96 may be used to convey radio-frequency signals using the control RAT or RIS 96 may include one or more antennas that are separate from array 98 for performing communications using the control RAT.

To minimize the cost, complexity, and power consumption of RIS 96, RIS 96 may include only the components and control circuitry required to control and operate array 98 to reflect THF signals 32. Such components and control circuitry may include components for adjusting the phase and magnitude responses (e.g., impedances) of antenna elements 100 as required to change the direction with which RIS 96 reflects THF signals 32 (e.g., as required to steer the RIS-AP beam and the RIS-UE beam, as shown by arrows 102). The components may include, for example, components that adjust the impedances or other characteristics of antenna elements 100 so that each antenna element exhibits a respective complex reflection coefficient, which determines the phase and amplitude of the reflected (re-radiated) signal produced by each antenna element (e.g., such that the signals reflected across the array constructively and destructively interfere to form a reflected signal beam in a corresponding beam pointing direction). All other components that would otherwise be present in UE device 10 or AP 6 may be omitted from RIS 96 (e.g., other processing circuitry, input/output devices such as a display or user input device, transceiver circuitry for generating and transmitting, receiving, or processing wireless data conveyed using THF signals 32, etc.). In other words, the control circuitry on RIS 96 may adjust the antenna elements 100 in array 98 to shape the electromagnetic waves of THF signals 32 (e.g., reflected/re-radiated THF signals 32) for the data transfer RAT without using antenna elements 100 to perform any data transmission or reception operations and without using antenna elements 100 to perform radio-frequency sensing operations. RIS 96 may also include components for communicating using the control RAT.

As one example, array 98 may be implemented using the components of phased antenna array 88 of FIG. 7. However, since RIS 96 does not actually generate or transmit wireless data using array 98 and the data transfer RAT, antenna elements 100 may be implemented without modulators, without a receiver, without a transmitter, without converter circuitry, without mixer circuitry, and/or without other circuitry involved in the transmission or reception of wireless data. If desired, each antenna element 100 may include a respective varactor diode or other impedance-adjusting device that is coupled to a corresponding antenna resonating element. The varactor diode or other impedance-adjusting device may be adjusted using control signals to adjust the impedance of the antenna element to change the phase/amplitude of the THF signals reflected by the antenna element for performing beamforming (e.g., antenna elements 100 may reflect THF signals 32 without the use of optical local oscillator signals, thereby allowing RIS 96 to also omit the LO light sources 70 and signal path 28 (FIG. 6), which may otherwise be implemented in UE device 10 and/or AP 6, to further reduce cost, complexity, and power consumption).

Consider an example in which each antenna element 100 includes a respective antenna resonating element 36 and UTC PD 42 as in antenna 30 of FIGS. 2-7. In this example, UTC PD 42 need not be supplied with optical local oscillator signals because antenna element 100 is only used for passive signal reflection and not for active signal transmission or reception. Control signals V_{BIAS} may include a bias voltage and/or other control signals that configure UTC PD 42 to exhibit a selected output impedance. UTC PD 42 may also be replaced with a varactor diode or other impedance-adjusting device configured to adjust the output impedance. The selected output impedance may be mismatched with respect to the input impedance of antenna resonating element 36 (e.g., at the frequencies of THF signals 32). This impedance mismatch may cause antenna element 100 to reflect (scatter) incident THF signals 32 as reflected (scattered) THF signals (e.g., with a corresponding complex reflection coefficient).

The selected impedance mismatch may also configure antenna element 100 to impart a selected phase shift and/or carrier frequency shift on the reflected THF signals relative to the incident THF signals 32 (e.g., where the reflected THF signals are phase-shifted with respect to THF signals 32 by the selected phase shift, are frequency-shifted with respect to THF signals 32 by the selected carrier frequency shift, etc.). Additionally or alternatively, the system may be adapted to configure antenna element 100 to impart polarization changes on the reflected THF signals relative to the incident THF signals 32. Control signals V_{BIAS} may change, adjust, or alter the output impedance of UTC PD 42 (or the varactor diode or other impedance-adjusting device) over time to change the amount of mismatch between the output impedance of UTC PD 42 (or the varactor diode or other device) and the input impedance of antenna resonating element 36 to impart the reflected THF signals with different phase shifts and/or carrier frequency shifts. In other words, control circuitry on RIS 96 (e.g., control circuitry with similar components and/or functionality as control circuitry 14 of FIG. 1) may program the phase, frequency, and/or polarization characteristics of the reflected THF signals (e.g., using the control signals V_{BIAS} applied to UTC PD 42, the varactor diode, or other device).

The same impedance mismatch may be applied to all the antenna elements 100 in array 98 or different impedance mismatches may be applied for different antennas elements 100 in array 98 at any given time. Applying different impedance mismatches across array 98 may, for example, allow the control circuitry in RIS 96 to form a RIS-UE beam and a RIS-AP beam that point in one or more desired (selected) beam pointing directions. This example in which control signal V_{BIAS} is used to adjust antenna impedance using UTC PD 42 is illustrative and non-limiting. In general, antenna elements 100 may be implemented using any desired antenna architecture (e.g., the antennas need not include photodiodes) and may include any desired structures that are adjusted by control circuitry (e.g., using control signals V_{BIAS} or other control signals) on RIS 96 to impart the THF signals 32 reflected by each antenna element 100 with a different relative phase such that the THF signals reflected by all antenna elements 100 collectively form a reflected signal beam (e.g., a RIS-UE beam or a RIS-AP beam) oriented in a desired (selected) beam pointing direction. Such structures (e.g., impedance-adjusting devices) may include adjustable impedance matching structures or circuitry, varactor diodes, adjustable phase shifters, adjustable amplifiers, optical phase shifters, antenna tuning elements, and/or any other desired structures that may be used to change the amount of impedance mismatch produced by antenna elements 100 at the frequencies of THF signals 32.

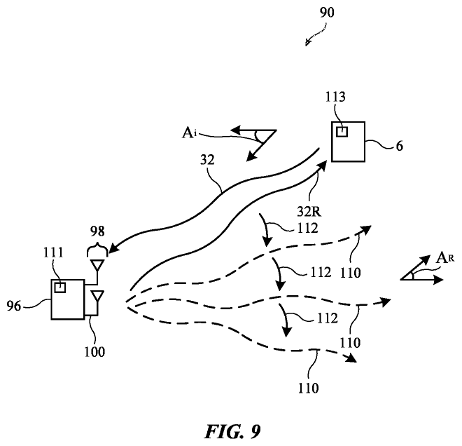

FIG. 9 is a diagram showing how two or more antenna elements 100 on RIS 96 (e.g., array 98) may reflect incident THF signals 32 transmitted by AP 6. As shown in FIG. 9, AP 6 may transmit THF signals 32. THF signals 32 may be incident upon RIS 96 at incident angle Ai. Antenna elements 100 in array 98 may reflect the THF signals 32 at incident angle Ai as reflected signals 32R. Control signals V_{BIAS} may be varied (e.g., thereby varying imparted phase shift) across array 98 to configure array 98 to collectively reflect THF signals 32 from incident angle Ai onto a corresponding output (scattered) angle A_{R} (e.g., as a reflected signal beam with a beam pointing direction in the direction of output angle A_{R}).

Control signals V_{BIAS} may configure output angle A_{R} to be any desired angle within the field of view of RIS 96. For example, output angle A_{R} may be oriented towards AP 6 so AP 6 receives reflected signals 32R. This may allow AP 6 to identify the position and orientation of RIS 96 (e.g., in situations where AP 6 has no a priori knowledge of the location and orientation of device RIS 96). If desired, control circuitry on RIS 96 may control output angle A_{R} to point in other directions, as shown by arrows 110. Arrows 110 may be oriented towards UE device 10 (e.g., as a portion 82B of the signal beam of FIG. 8). If desired, UE device 10 may identify the location and orientation of RIS 96 based on receipt of reflected signals 32R. If desired, the control circuitry on RIS 96 may sweep reflected signals 32R over a number of different output angles A_{R} as a function of time, as shown by arrows 112. This may, for example, help RIS 96 to establish a THF signal relay between UE device 10 and AP 6, to find other UE devices for relaying THF signals, and/or to maintain a THF signal relay between UE device 10 and AP 6 even as UE device 10 and/or object 94 (FIG. 8) move over time. The example of FIG. 9 is illustrative and non-limiting. Signals 32 may be reflected in three dimensions. RIS 96 may reflect signals transmitted by UE device 10 towards AP 6 while implementing beam steering.

In practice, AP 6 and RIS 96 are generally stationary within environment 90, whereas UE device 10 and object 94 may move over time. It can be challenging to initiate communications between AP 6 and UE device 10 via RIS 96 in this type of environment, particularly because AP 6 needs to know the relative position and orientation of RIS 96 to correctly form its AP signal beam, UE device 10 needs to know the relative position and orientation of RIS 96 to correctly form its UE signal beam, and AP 6 or UE device 10 needs to know the relative position and orientation of RIS 96 to control RIS 96 (e.g., via the control RAT) to correctly form its RIS-AP beam and RIS-UE beam. However, AP 6 and UE device 10 have no a priori knowledge of the relative position and orientation of RIS 96 prior to beginning THF communications via RIS 96.

The relative position and orientation of RIS 96 may, for example, be defined by six degrees of freedom: three translational positions along the X, Y, and Z axes of FIG. 8 and three rotational positions such as tilt (pitch), rotation (roll), and yaw, as shown by arrows 104, 106, and 108 of FIG. 8). In some scenarios, RIS 96 may include sensors (e.g., accelerometers, gyroscopes, compasses, image sensors, light sensors, radar sensors, acoustic sensors, etc.) that identify the relative position and orientation of RIS 96. In these scenarios, RIS 96 may use the control RAT to inform AP 6 and/or UE device 10 of the relative position and orientation. However, including such sensors on RIS 96 would undesirably increase the cost, complexity, and power consumption of RIS 96. It would therefore be desirable to be able to establish and maintain THF communications between UE device 10 and AP 6 via RIS 96 without the use of such sensors on RIS 96.

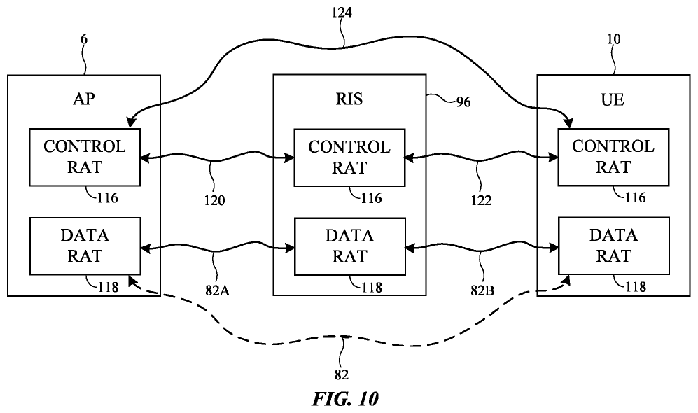

FIG. 10 is a diagram showing how AP 6, RIS 96, and UE device 10 may communicate using both a control RAT and a data transfer RAT for establishing and maintaining communications between AP 6 and UE device 10 via RIS 96. As shown in FIG. 10, AP 6, RIS 96, and UE device 10 may each include wireless circuitry that operates according to a data transfer RAT 118 (sometimes referred to herein as data RAT 118) and a control RAT 116. Data RAT 118 may be a sub-THz communications RAT such as a 6G RAT that performs wireless communications at the frequencies of THF signals 32. Control RAT 116 may be associated with wireless communications that consume much fewer resources and are less expensive to implement than the communications of data RAT 118. For example, control RAT 116 may be Wi-Fi, Bluetooth, a cellular telephone RAT such as a 3G, 4G, or 5G NR FR1 RAT, etc. As another example control RAT 116 may be an infrared communications RAT (e.g., where an infrared remote control or infrared emitters and sensors use infrared light to convey signals for the control RAT between UE device 10, AP 6, and/or RIS 96).

AP 6 and RIS 96 may use control RAT 116 to convey radio-frequency signals 120 (e.g., control signals) between AP 6 and RIS 96. UE device 10 and RIS 96 may use control RAT 116 to convey radio-frequency signals 122 (e.g., control signals) between UE device 10 and RIS 96. UE device 10, AP 6, and RIS 96 may use data RAT 118 to convey THF signals 32 within the reflected signal beam (e.g., within portion 82A between AP 6 and RIS 96 and portion 82B between RIS 96 and UE device 10). The RIS-UE beam and the RIS-AP beam formed by RIS 96 may operate on THF signals transmitted using data RAT 118 to reflect the THF signals between AP 6 and UE device 10. AP 6 may use radio-frequency signals 120 and control RAT 116 and/or UE device 10 may use radio-frequency signals 122 and control RAT 116 to discover RIS 96 and to configure antenna elements 100 to establish and maintain the relay of THF signals 32 performed by antenna elements 100 using data RAT 118.

If desired, AP 6 and UE device 10 may also use control RAT 116 to convey radio-frequency signals 124 directly with each other (e.g., since the control RAT operates at lower frequencies that do not require line-of-sight). UE device 10 and AP 6 may use radio-frequency signals 124 to help establish and maintain THF communications (communications using data RAT 118) between UE device 10 and AP 6 via RIS 96. AP 6 and UE device 10 may also use data RAT 118 to convey THF signals 32 within an uninterrupted signal beam 82 (e.g., a signal beam that does not reflect off RIS 96) when LOS path 92 (FIG. 8) is available. If desired, the same control RAT 116 may be used to convey radio-frequency signals 120 between AP 6 and RIS 96 and to convey radio-frequency signals 122 between RIS 96 and UE device 10. If desired, AP 6, RIS 96, and/or UE device 10 may support multiple control RATs 116. In these scenarios, a first control RAT 116 (e.g., Bluetooth) may be used to convey radio-frequency signals 120 between AP 6 and RIS 96, a second control RAT 116 (e.g., Wi-Fi) may be used to convey radio-frequency signals 122 between RIS 96 and UE device 10, and/or a third control RAT 116 may be used to convey radio-frequency signals 124 between AP 6 and UE device 10.

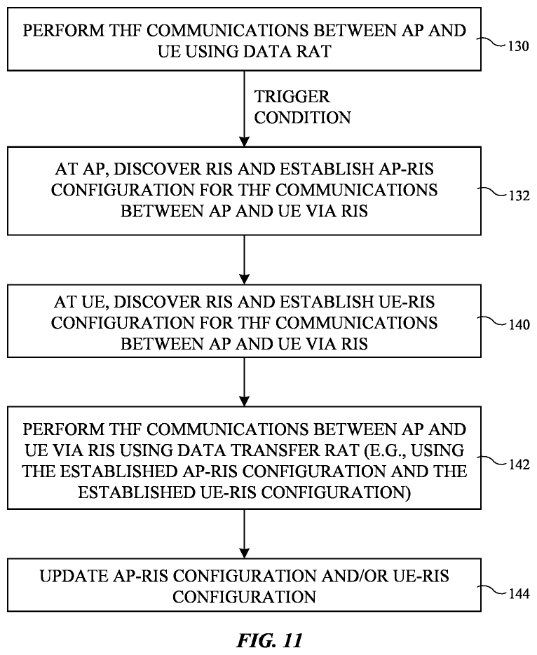

FIG. 11 is a flow chart of illustrative operations involved in performing THF communications between AP 6 and UE device 10 via RIS 96. At operation 130, AP 6 and UE device 10 may perform THF communications using data transfer RAT 118. For example, AP 6 and UE device 10 may use signal beam 82 to convey THF signals 32 over LOS path 92 (FIG. 8). Signal beam 82 may be supported by an AP beam formed by phased antenna array 88′ on AP 6 and a corresponding UE beam formed by phased antenna array 88 on UE device 10.

Upon the occurrence or detection of a trigger condition indicating that THF communications should be relayed via RIS 96, processing may proceed to operation 132. The trigger condition may occur when object 94 blocks LOS path 92, when UE device 10 and/or AP 6 measures wireless performance metric data that is outside a range of acceptable wireless performance metric data values, when THF signals 32 are otherwise blocked or not received at UE device 10 and/or AP 6, periodically, at a specified time, upon receipt of a user input at UE device 10 or AP 6, upon power on of RIS 96, upon gathered sensor data falling within a predetermined range of values, or any other desired trigger condition. Alternatively, operation 130 may be omitted.

At operation 132, AP 6 may discover RIS 96 and may establish a configuration for RIS 96 and AP 6 to communicate using data transfer RAT 118 by conveying THF signals 32 between AP 6 and UE device 10 (sometimes referred to herein as an AP-RIS configuration or RIS-AP configuration). In general, phased antenna array 88′ may be able to form a set of different AP beams, where each AP beam in the set is oriented in a different respective beam pointing direction. Each AP beam may be defined by a corresponding AP beam index m_{AP}. AP 6 may have a codebook 113 (FIG. 9) that identifies the settings (e.g., beamforming coefficients, phase settings, impedance settings, magnitude settings, etc.) for each antenna 30′ in phased antenna array 88′ corresponding to each AP beam index mA (e.g., codebook 113 may store the settings for each antenna 30′ to form each AP beam in the set of formable AP beams).

Codebook 113 may be hardcoded and/or soft-coded on AP 6 (e.g., codebook 113 may include a table, database, register, or other data object stored on AP 6).

In general, array 98 on RIS 96 may be able to form a set of different RIS-AP beams each oriented in a different respective direction and may be able to form a set of different RIS-UE beams each oriented in a different respective direction. RIS 96 may, for example, concurrently form one of the RIS-AP signal beams in the set of RIS-AP signal beams and one of the RIS-UE signal beams in the set of RIS-UE signal beams. The signal beams formed by RIS 96 at any given instant may sometimes be referred to herein as active beams. The each RIS-UE beam in the set of RIS-UE beams formable by RIS 96 may be defined or labeled by a corresponding RIS-UE beam index. Similarly, each RIS-AP beam in the set of RIS-AP beams may be defined or labeled by a corresponding RIS-AP beam index. The settings for antenna elements 98 that are used to form the RIS-UE and RIS-AP beams (e.g., beamforming coefficients, phase settings, magnitude settings, impedance settings, etc.) and the corresponding RIS-UE and RIS-AP beam indices may be stored in a codebook 111 on RIS 96 (FIG. 9). The RIS-AP beam indices and the RIS-UE beam indices may each be labeled with a respective RIS beam index m_{RIS} and there may be M_{RIS} total RIS beam indices in codebook 111 (e.g., where M_{RIS} includes both the RIS-AP beam indices and the RIS-UE beam indices). Codebook 111 may be hardcoded and/or soft-coded on RIS 96 (e.g., codebook 111 may include a table, database, register, or other data object stored on RIS 96).

The AP-RIS configuration may include an optimal AP beam that is oriented towards RIS 96 (e.g., the corresponding AP beam index m_{AP} and/or settings for phased antenna array 88′). Establishing the AP-RIS configuration may involve identifying/finding the optimal AP beam and a RIS-AP beam that points back towards AP 6. Once the AP-RIS configuration has been established, AP 6 has knowledge of the relative position and orientation of RIS 96 with respect to AP 6. AP 6 can then use this information to know how to direct the AP beam and how to control RIS 96 to reflect THF signals at different angles between AP 6 and UE device 10 via RIS 96.

As a part of discovering RIS 96 and establishing the AP-RIS configuration, AP 6 may first perform a control RAT discovery of RIS 96. The control RAT discovery may involve using control RAT 116 and radio-frequency signals 120 to identify the presence of RIS 96 to AP 6 and optionally one or more characteristics of RIS 96 for use in performing subsequent THF communications using data transfer RAT 118. Once RIS 96 has been discovered using control RAT 116, AP 6 may then perform a data transfer RAT discovery of RIS 96. The data transfer RAT discovery may involve using data transfer RAT 118 and/or control RAT 116 to set up and establish the AP-RIS configuration (e.g., to identify the optimal AP beam and the RIS-AP beam that points towards AP 6). As AP 6 and RIS 96 are generally fixed in place and do not move with respect to each other, it is assumed that the AP-RIS configuration is fixed upon discovery by AP 6. As such, the RIS-AP beam and the AP beam are assumed to remain fixed during the remaining operations of FIG. 11 (e.g., the remaining operations of FIG. 11 may be used to identify and update the RIS-UE beam and the UE beam as the UE moves over time). This is merely illustrative and, if AP 6 or RIS 96 moves over time, operation 132 may be repeated (e.g., processing may loop back to operation 132 of FIG. 11 as needed).

At operation 140, UE device 10 may discover RIS 96 and may establish a configuration for RIS 96 and UE device 10 to communicate using data transfer RAT 118 by conveying THF signals 32 between AP 6 and UE device 10 (sometimes referred to herein as a UE-RIS configuration or RIS-UE configuration). Phased antenna array 88 on UE device 10 may form a corresponding UE beam. In general, phased antenna array 88 may be able to form a set of different UE beams, where each UE beam in the set is oriented in a different respective beam pointing direction. Each UE beam may be defined by a corresponding UE beam index m_{UE}. UE device 10 may have a corresponding codebook that identifies the settings (e.g., phase settings, beamforming coefficients, impedance settings, magnitude settings, etc.) for each antenna 30 in phased antenna array 88 corresponding to each UE beam index m_{UE} (e.g., the codebook may store the settings for each antenna 30 to form each UE beam in the set of formable UE beams). The codebook may be hardcoded and/or soft-coded on UE device 10 (e.g., the codebook may include a table, database, register, or other data object stored on UE device 10).

The UE-RIS configuration may include an optimal UE beam that is oriented towards RIS 96 and an optimal RIS-UE beam that is oriented back towards UE device 10. Establishing the UE-RIS configuration may involve identifying/finding the optimal UE beam and the optimal RIS-UE beam. Once the UE-RIS configuration has been established, UE device 10 has knowledge of the relative position and orientation of RIS 96 with respect to UE device 10. UE device 10 can then use this information to know how to direct the UE signal beam and how to control RIS 96 to reflect THF signals between AP 6 and UE device 10 via RIS 96. Additionally or alternatively, AP 6 may inform UE device 10 (e.g., via control RAT 116 and radio-frequency signals 124 of FIG. 10) of the presence of RIS 96, its capabilities, its formable signal beams, its position and orientation, the optimal AP signal beam, and/or the optimal RIS-AP and RIS-UE signal beams.

At operation 142, AP 6 and UE device 10 may perform THF communications via RIS 96 using data transfer RAT 118. The AP-RIS configuration and the UE-RIS configuration as discovered and established while processing operations 132 and 140 may configure RIS 96 to relay THF signals 32 between UE device 10 and AP 6. For example, AP 6 may transmit THF signals 32 within its AP beam and RIS 96 may reflect THF signals 32 incident in the direction of its RIS-AP beam onto the direction of its RIS-UE beam, which is oriented towards UE device 10. Conversely, UE device 10 may transmit THF signals 32 within its UE beam and RIS 96 may receive THF signals 32 incident in the direction of its RIS-UE beam onto the direction of its RIS-AP beam oriented towards AP 6. This may allow AP 6 and UE device 10 to perform very high data rate communications using THF signals despite not having LOS path 92, while minimizing the cost, complexity, and power consumption of RIS 96.

At operation 144, AP 6 and/or UE device 10 may update the AP-RIS configuration and/or the UE-RIS configuration as needed. This may, for example, involve updating the AP beam (e.g., selecting a new AP signal beam oriented in a new beam pointing direction), the RIS-UE beam and/or the RIS-AP beam (e.g., selecting a new setting for the phases, magnitudes, beamforming coefficients, and/or impedances of the antenna elements 100 in array 98), and/or the UE beam (e.g., selecting a new UE signal beam oriented in a new beam pointing direction) to account for movement of UE device 10 (e.g., to allow the signal beams to continue to track UE device 10 via RIS 96 as the UE device moves over time) or to otherwise optimize wireless performance. If desired, the beams may be updated based on the position and orientation of RIS 96 relative to AP 6 and/or relative to UE device 10 as discovered while processing operation 132 and/or operation 140. For example, if UE device 10 changes its location by a known or detected amount, the position and orientation of RIS 96 can be used to identify a new AP beam, RIS-UE beam, RIS-AP beam, and/or UE beam that would allow RIS 96 to reflect THF signals 32 between AP 6 and UE device 10 at the new location. If desired, AP 6 and/or UE device 10 may program one or more new codebook entries for the codebook on RIS 96 (e.g., using the control RAT). Additionally or alternatively, processing may loop back to operation 132 to re-discover RIS 96 and/or may loop back to operation 130 (e.g., when object 94 is no longer blocking LOS path 92 of FIG. 8).

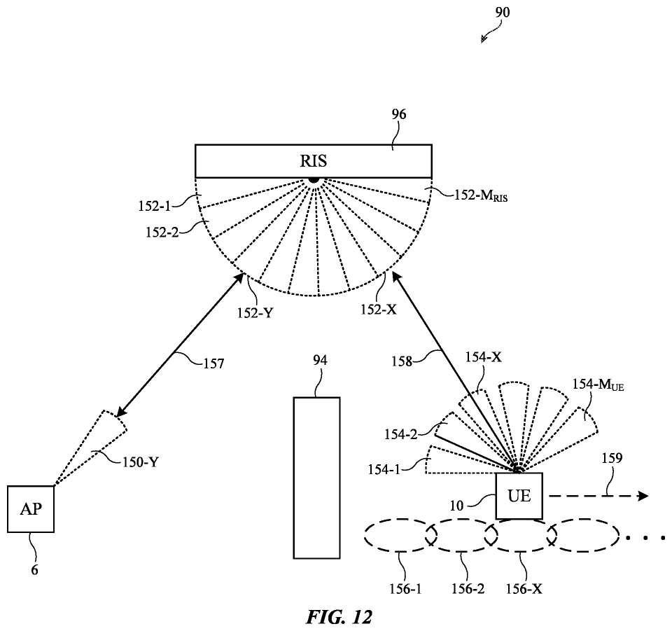

FIG. 12 is a side view showing how RIS 96 may use different RIS beams to maintain communication between AP 6 and UE device 10 as UE device 10 moves over time. As shown in FIG. 12, AP 6 and RIS 96 may be disposed at fixed locations within environment 90. Object 94 may block the LOS path between AP 6 and UE device 10. RIS 96 may have a set of RIS beams 152. RIS beams 152 may include both RIS-AP beams and RIS-UE beams (e.g., RIS 96 may concurrently form at least two RIS beams 152 at once: at least one RIS-AP beam and at least one RIS-UE beam). The beamforming coefficients, impedance settings, phase settings, and/or magnitude settings to be used by each of the antenna elements in RIS 96 to form different RIS beams 152 may be stored in a codebook on RIS 96. RIS 96 may have M_{RIS} total RIS beams 152 (e.g., a first RIS beam 152-1, a second RIS beam 152-2, an M_{RIS}^{th} RIS beam 152-M_{RIS}, etc.). The M_{RIS} total RIS beams 152 may include both RIS-UE and RIS-AP beams. AP 6 may have an AP beam 150-Y that points towards RIS 96 (e.g., an optimal AP beam as found while processing operation 132 of FIG. 11). RIS 96 may have a corresponding RIS-AP beam 152-Y that points towards AP 6 (e.g., an optimal RIS-AP beam). Assuming that RIS 96 and AP 6 remain fixed within environment 90 over time, RIS 96 may use RIS-AP beam 152-Y to reflect THF signals to/from AP 6 while the RIS-UE beam is adjusted to account for the mobility of UE device 10.

UE device 10 may have a set of UE beams 154. The phase and/or magnitude settings (e.g., beamforming coefficients) for each antenna 30 in phased antenna array 88 on UE device 10 (FIG. 8) may be stored in a codebook on UE device 10. UE device 10 may have M_{UE} total UE beams 154 (e.g., a first UE beam 154-1, a second UE beam 154-2, an M_{UE}^{th} UE beam 154-M_{UE}, etc.). Each RIS-UE beam in RIS beams 152 may overlap a respective area 156 within environment 90 (e.g., a respective area 156-1, 156-2, 156-X, etc.). Areas 156 may sometimes be referred to herein as spot beams or beam footprints 156. At a given point in time, UE device 10 may be located within the beam footprint 156-X of RIS-UE beam 152-X in environment 90. RIS-UE beam 152-X points towards UE device 10 within beam footprint 156-X (e.g., beam footprint 156-X may be defined by the width of RIS-UE beam 152-X). While within beam footprint 156-X, UE device 10 may have a corresponding UE beam 154-X that points towards RIS 96. RIS-UE beam 152-X and/or UE beam 154-X may be found while processing operation 142 of FIG. 11, for example. RIS-UE beam 152-X may be identified by a corresponding beam index within the codebook of RIS 96 (e.g., a RIS-UE beam index from the M_{RIS} total beam indices in the codebook of RIS 96). Similarly, UE beam 154-X may be identified by a corresponding index within the codebook of UE device 10. When the antenna elements on RIS 96 are programed to concurrently exhibit responses that form RIS-UE beam 152-X and that form RIS-AP beam 152-Y, THF signals transmitted by AP 6 and incident within RIS-AP beam 152-Y (as shown by arrow 157) may be reflected by RIS 96 towards UE device 10 within RIS-UE beam 152-X (as shown by arrow 158). Conversely, THF signals transmitted by UE device 10 and incident within RIS-UE beam 152-X may be reflected by RIS 96 towards AP 6 within RIS-AP beam 152-Y.

In practice, RIS beams 152 are very narrow (e.g., having 3 dB beam widths around 1 degree), which causes each beam footprint 156 to be relatively small (e.g., depending on the distance between RIS 96 and UE device 10). At the same time, UE device 10 is mobile and often moves or rotates while operated by a user. Given the narrow width of beam footprints 156, even a slow-moving user can cause UE device 10 to quickly move out of beam footprint 156-X (e.g., as quickly as within 10-100 ms). The active RIS-UE beam and/or UE beam 154 (sometimes referred to herein as serving beams or serving signal beams) therefore need to be updated frequently (e.g., every 10-100 ms). For example, when UE device 10 rotates or moves in the direction of arrow 159, the active RIS-UE beam and the active UE beam 154 may need to be updated for RIS 96 to continue to reflect THF signals between AP 6 and UE device 10.

When UE device 10 moves out of the active beam footprint 156-X, the control RAT may be used to control RIS 96 to scan over the RIS-UE beams in the M_{RIS} total beams identified by the codebook for RIS 96 and to control UE device 10 to scan over its UE beams 154 until a RIS-UE beam that points towards UE device 10 and a UE beam 154 that points towards RIS 96 are found. In some implementations, the beam tracking involves AP 6 sending a control signal to RIS 96 to control RIS 96 to form a first RIS-UE beam. RIS 96 then transmits a control signal to AP 6 and to UE device 10 confirming that it has formed the first RIS-UE beam. AP 6 then transmits reference signals to RIS 96 over the optimal AP beam and UE device 10 sweeps over each of its UE beam while RIS 96 forms the first RIS-UE beam. Once every UE beam has been swept over, AP 6 then sends a control signal to RIS 96 to control RIS 96 to form a second RIS-UE beam. RIS 96 then transmits a control signal to AP 6 and to UE device 10 confirming that it has formed the second RIS-UE beam. AP 6 then transmits reference signals to RIS 96 over the optimal AP beam and UE device 10 sweeps over each of its UE beam while RIS 96 forms the second RIS-UE beam. Once every UE beam has been swept over, AP 6 then sends a control signal to RIS 96 to control RIS 96 to form a third RIS-UE beam. RIS 96 then transmits a control signal to AP 6 and to UE device 10 confirming that it has formed the third RIS-UE beam. This process continues until RIS 96 has swept through all of its RIS-UE beams, at which point UE device 10 notifies AP 6 about the RIS-UE beam with which it received a reference signal reflected off RIS 96. UE device 10 will have knowledge of the RIS-UE beam that reflected the reference signal it received because UE device 10 will have received a control signal from RIS 96 identifying its current RIS-UE beam just prior to UE device 10 receiving the reference signal.

In these implementations, there is repeated explicit control signaling after RIS 96 forms each of its RIS beams, which allows UE device 10 to have knowledge of which RIS-UE beam is the optimal RIS-UE beam oriented towards UE device 10. Each of these handshake control interactions between RIS 96, AP 6, and UE device 10 can take on the order of milliseconds to perform. This can introduce excessive delay and latency with which UE device 10 discovers or updates the optimal RIS-UE beam (e.g., on the order of seconds to minutes), particularly given that RIS 96 may have tens of thousands of RIS-UE beams to sweep through. This type of beam sweep control signaling can therefore be detrimental to the user experience of UE device 10 and is generally not suitable for dynamic scenarios where UE device 10 and/or external object 94 move within environment 90.

To mitigate these issues, the control signaling used to control beam sweeps for identifying/updating the optimal RIS-UE beam of RIS 96 (e.g., either during an initial discovery at operation 140 of FIG. 11 or during an update of the RIS-UE beam configuration at operation 144 of FIG. 11) may be performed without handshake procedures for every RIS-UE beam and with the timing of AP 6 and UE device 10 decoupled from the timing of RIS 96 (e.g., where RIS 96 does not provide control signals to AP 6 and UE device 10 after forming each RIS-UE beam). Control communication may, for example, be performed to initially trigger the sweep over RIS-UE beams and for a final confirmation after the sweep has been completed. AP 6 may radiate reference signals towards RIS 96 while RIS 96 autonomously sweeps over its RIS-UE beams based on a predetermined timing from an initial time associated with the initial trigger of the sweep. During the autonomous sweep over RIS-UE beams, UE device 10 may scan for incoming beams and may detect the optimal RIS-UE beam while determining its own UE beam. UE device 10 may use the timing with which UE device 10 receives a reference signal reflected off RIS 96 relative to the initial trigger to deduce the optimal RIS-UE beam that reflected the reference signal towards UE device 10 and may report the optimal RIS-UE beam to AP 6 during the final confirmation after the sweep. The overall speed of the discovery process is therefore limited primarily by the reconfiguration/switching time of RIS 96. Such a control signaling scheme does not require clocking with extreme precision on RIS 96 or tight synchronization mechanisms with the AP and/or UE device (thereby allowing RIS 96 to utilize only simple, cost-effective clocks/oscillators), does not require significant time tracking control overhead between RIS 96, AP 6, and UE device 10 (thereby minimizing power consumption associated with control signaling), and does not require any measurement of the THF signals at RIS 96 (thereby minimizing the signal processing need and thus the cost of RIS 96).

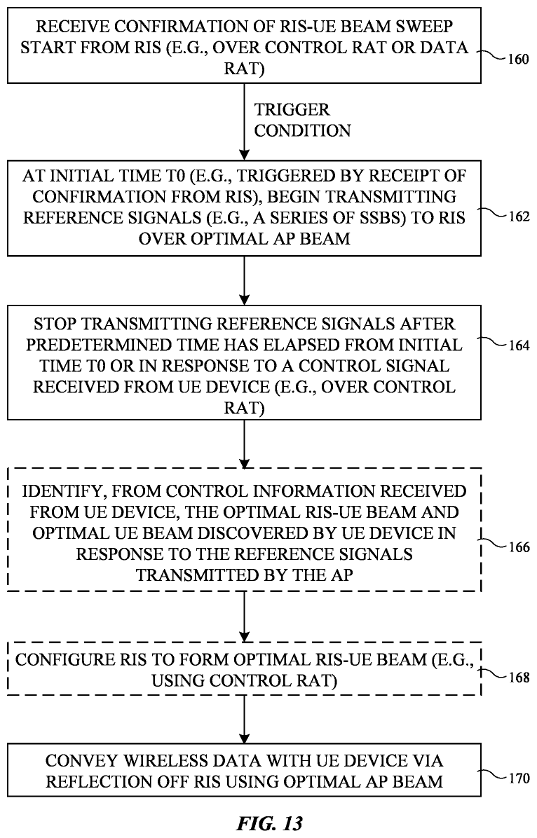

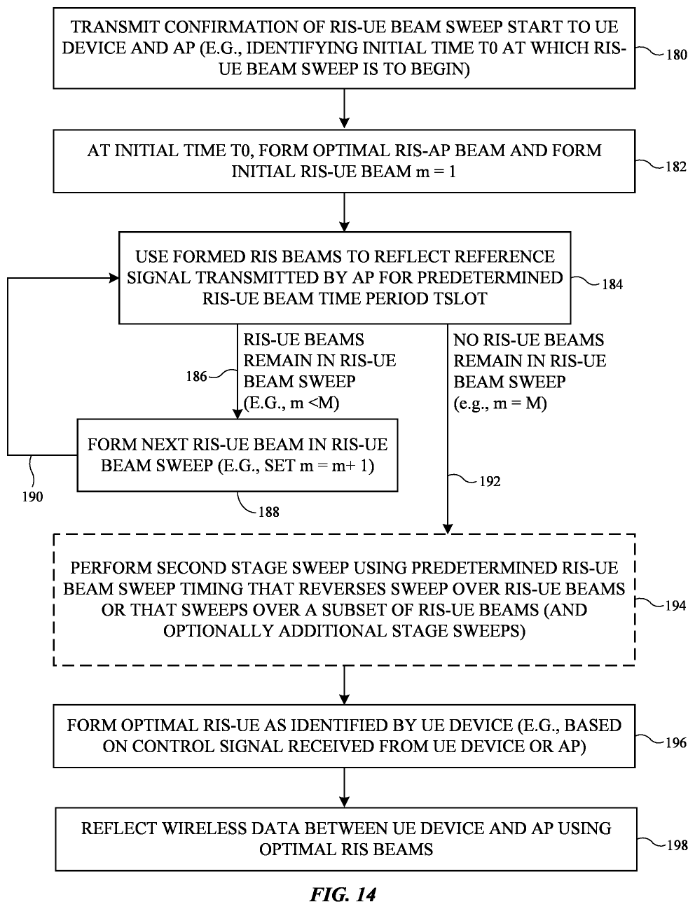

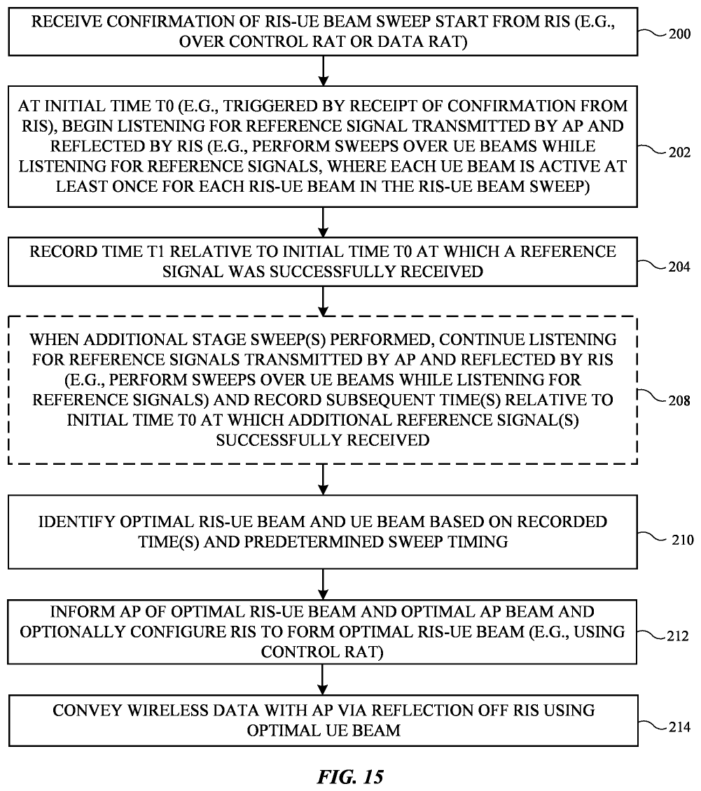

FIGS. 13-15 are flow charts of illustrative operations involved in using AP 6, RIS 96, and UE device 10 to discover or update the optimal RIS-UE beam for serving UE device 10 at its present location within environment 90. The operations of FIG. 13 may be performed concurrently with the operations of FIG. 14 and the operations of FIG. 15 may be performed concurrently with the operations of FIGS. 13 and 14. The operations of FIGS. 13-15 may be performed during initial discovery and establishment of the UE-RIS configuration by UE device 10 (e.g., while processing operation 140 of FIG. 11) and/or while tracking UE device 10 after already establishing a wireless link to UE device 10 via RIS 96 (e.g., while updating the UE-RIS configuration at operation 144 of FIG. 11).

FIG. 13 is a flow chart of illustrative operations that may be performed by AP 6 during discovery/update of the optimal RIS-UE beam by UE device 10 and with the timing of AP 6 and UE device 10 decoupled from the timing of RIS 96. The operations of FIG. 13 may be performed after AP 6 has already discovered RIS 96 and established the AP-RIS configuration (e.g., the optimal AP beam oriented towards RIS 96 and the optimal RIS-AP beam oriented towards UE device 10).

At operation 160, AP 6 may receive confirmation from RIS 96 that RIS 96 is going to begin to sweep over RIS-UE beams (in a procedure sometimes referred to herein as a RIS-UE beam sweep). This confirmation may serve as an initial trigger for AP 6 to begin transmission of reference signals. The confirmation may identify an initial time T0 at which AP 6 is to begin transmitting reference signals and at which RIS 96 is going to begin sweeping over RIS-UE beams. AP 6 may receive the confirmation from RIS 96 in a control signal transmitted over the control RAT, for example.

At operation 162, AP 6 may begin transmitting reference signals at initial time T0 (e.g., the initial time T0 as identified by the confirmation received from RIS 96). The start of reference signal transmission may, for example, be triggered by the receipt of the confirmation from RIS 96 (e.g., initial time T0 and thus the start of reference signal transmission be after a predetermined duration from receipt of the confirmation, after a predetermined duration identified in the received confirmation, etc.). AP 6 may transmit the reference signals in THF signals 32 (e.g., using the data RAT) within the optimal AP beam oriented towards RIS 96. The reference signals may include synchronization reference signals such as a series of synchronization signal blocks (SSBs), for example. The synchronization reference signals may, for example, allow UE device 10 to detect the presence of AP 6 and to synchronize to AP 6. RIS 96 may reflect the reference signals as it sweeps over its RIS-UE beams.

At operation 164, AP 6 may stop transmitting reference signals to RIS 96. AP 6 may stop transmitting the reference signals after a predetermined time period has elapsed from initial time T0. The predetermined time period may be a RIS-UE beam sweep time TSWEEP (sometimes referred to herein as RIS-UE beam sweep duration TSWEEP or RIS-UE beam sweep time period TSWEEP), may be twice RIS-UE beam sweep time (e.g., 2*TSWEEP), or any other predetermined time period. The predetermined time period may, for example, be identified by the confirmation received from RIS 96 at operation 160. Additionally or alternatively, AP 6 may stop transmitting the reference signals upon or in response to receipt of a control signal from RIS 96 (e.g., via the control RAT) identifying that RIS 96 has stopped sweeping over RIS-UE beams and/or receipt of a control signal (e.g., via the control RAT) identifying that UE device 10 has stopped receiving reference signals or that UE device 10 has identified the optimal RIS-UE beam.

At optional operation 166, AP 6 may receive a control signal from UE device 10 (e.g., via the control RAT) that identifies the optimal RIS-UE beam identified by UE device 10 from the reference signals transmitted by AP 6 while RIS 96 swept over its RIS-UE beams. The control signal may additionally or alternatively identify the optimal UE beam identified by UE device 10 from the reference signals transmitted by AP 6 while RIS 96 swept over its RIS-UE beams.

At optional operation 168, AP 6 may configure (program) RIS 96 to form the optimal RIS-UE beam identified by UE device 10. AP 6 may, for example, transmit a control signal to RIS 96 (e.g., via the control RAT) that controls the antenna elements on RIS 96 to form the optimal RIS-UE beam, that programs, adds, or updates an entry in the codebook of RIS 96, that instructs RIS 96 to activate the optimal RIS-UE beam from its codebook, etc. Operations 166 and/or 168 may be omitted in implementations where UE device 10 configures (programs) RIS 96 to form the optimal RIS-UE beam.

At operation 170, AP 6 may convey wireless data in THF signals 32 with UE device 10 via reflection of the THF signals off RIS 96. AP 6 may convey the THF signals using the optimal AP beam. RIS 96 may reflect the THF signals using the optimal RIS-AP beam and the optimal RIS-UE beam. UE device 10 may convey the THF signals using the optimal UE beam. If desired, processing may loop back to operation 160 periodically, when UE device 10 moves or rotates, when UE device 10 and/or AP 6 gather wireless performance metric data from the THF signals that falls outside a range of acceptable values, or in response to any desired trigger condition to update the optimal RIS-UE beam and/or the optimal UE beam.

FIG. 14 is a flow chart of illustrative operations that may be performed by RIS 96 during discovery/update of the optimal RIS-UE beam by UE device 10 and with the timing of AP 6 and UE device 10 decoupled from the timing of RIS 96. The operations of FIG. 14 may be performed after AP 6 has already discovered RIS 96 and established the AP-RIS configuration (e.g., the optimal AP beam oriented towards RIS 96 and the optimal RIS-AP beam oriented towards UE device 10).

At operation 180, RIS 96 may transmit a confirmation that RIS 96 is going to begin to sweep over RIS-UE beams to AP 6 and UE device 10. RIS 96 may transmit the confirmation to UE device 10 and AP 6 over the control RAT, for example. The confirmation may serve as an initial trigger for AP 6 to begin transmission of reference signals. The confirmation may also serve as an initial trigger for UE device 10 to begin listening for reference signals reflected off RIS 96. The confirmation may identify the initial time T0 at which AP 6 is to begin transmitting reference signals, at which RIS 96 is going to begin sweeping over RIS-UE beams, and at which UE device 10 is to begin listening for reference signals reflected off RIS 96.

At operation 182, RIS 96 may form the optimal RIS-AP beam oriented towards AP 6. RIS 96 may concurrently form (activate) an initial RIS-UE beam from its sweep of RIS-UE beams. RIS 96 may have M total formable RIS-UE beams. Each RIS-UE beam may be labeled by an index m, which includes the set of integers from 1 to M. The initial RIS-UE beam is the RIS-UE beam having the index m=1. The codebook on RIS 96 may identify each RIS-UE beam by its corresponding index and may include the settings for the antenna elements 100 that configure (program) the antenna elements to form the corresponding RIS-UE beam.

At operation 184, RIS 96 may reflect reference signals incident in the direction of the formed (active) RIS-AP beam onto the direction of the formed (active) RIS-UE beam. RIS 96 may then begin to sweep through each of its RIS-UE beams using a predetermined timing relative to initial time T0. RIS 96 may sweep (scan) through each of the RIS-UE beams without receiving additional control signals from UE device 10 or AP 6 and without transmitting confirmations to AP 6 or UE device 10 after forming each of the RIS-UE beams in the sweep. For example, RIS 96 may form each RIS-UE beam for a predetermined RIS-UE beam time period TSLOT (sometimes referred to herein as RIS-UE beam time slot TSLOT, RIS-UE beam duration TSLOT, or RIS-UE beam time TSLOT). In other words, each step in the RIS-UE beam sweep may last for the predetermined RIS-UE beam time period TSLOT. RIS-UE beam time period TSLOT may be known to UE device 10 and AP 6 (e.g., via software running on UE device 10 and AP 6 and/or the confirmation transmitted by RIS 96 may identify RIS-UE beam time period TSLOT).

Once RIS-UE beam time period TSLOT has elapsed while the initial RIS-UE beam is active on RIS 96, RIS 96 may increment the active RIS-UE beam. If RIS-UE beams remain in the RIS-UE beam sweep (e.g., if the current RIS-UE beam index m is less than M), processing may proceed to operation 188 via path 186. At operation 188, RIS 96 may form (activate) the next RIS-UE beam in the RIS-UE beam sweep. For example, RIS 96 may increment the beam index (e.g., may set m=m+1) and may form the RIS-UE beam identified by the incremented beam index. Processing may then loop back to operation 184 via path 190 and RIS 96 may reflect incident reference signals in the direction of the formed (active) RIS-UE beam. RIS 96 will reflect the incident reference signals in different direction during each step of the RIS-UE beam sweep. Most of the reflected reference signals will be scattered in a random direction. However, one or more of the reflected reference signals will be reflected towards and received by UE device 10. The RIS-UE beam(s) that reflected the reference signal(s) towards UE device 10 may be the optimal RIS-UE beam(s). When the RIS-UE beam sweep is complete (e.g., when no RIS-UE beams remain in the RIS UE beam sweep or when the current beam index m is equal to M), processing may proceed from operation 184 to optional operation 194 via path 192.

Operations 184-188 may sometimes be referred to as a first stage sweep over RIS-UE beams or as a first RIS-UE beam sweep. At optional operation 194, RIS 96 may perform a second stage sweep over one or more of the RIS-UE beams (e.g., by sweeping through different formed RIS-UE beams while continuing to reflect incident reference signals transmitted by AP 6). RIS 96 may perform the second stage sweep (sometimes referred to herein as a second RIS-UE beam sweep) autonomously, for example. The second stage sweep may have predetermined sweep timing that is known to UE device 10 and/or AP 6. For example, each step in the sweep may last for RIS-UE beam time period TSLOT. The second stage sweep may last for RIS-UE beam sweep duration TSWEEP or some other duration known to UE device 10.

As one example, the second stage sweep may include a sweep over the same RIS-UE beams swept over while looping through operations 184-188 (e.g., all of the RIS-UE beams of RIS 96) but in reverse order (e.g., from beam index m=M to beam index m=1). This type of second stage sweep may last for RIS-UE beam sweep duration TSWEEP. As another example, the second stage sweep may include a sweep over a subset of the RIS-UE beams swept over while looping through operations 184-188 or any other subset of the RIS-UE beams formable by RIS 96 (e.g., some but not all of the RIS-UE beams of RIS 96). The second stage sweep may help to mitigate timing errors that may arise while UE device 10 listens for reference signals reflected off RIS 96 (e.g., to overcome unknown absolute time offsets and/or different timing drifts between RIS 96 and UE device 10), which might otherwise produce uncertainty or ambiguity about which RIS-UE beam is the optimal RIS-UE beam. Operation 194 may be omitted if desired. If desired, additional sweep stages such as at least a third stage sweep may be performed after the second stage sweep. The third stage sweep may be over a subset of the RIS-UE beams, for example. The third stage sweep may help to further resolve timing ambiguities in identifying the optimal RIS-UE beam. RIS 96 may receive control signals from UE device 10 (e.g., after completion of the first stage sweep or, when the second stage sweep is performed, after the second stage sweep) identifying when and how to perform the third and subsequent stage sweeps.

At operation 196, RIS 96 may receive a control signal from AP 6 and/or UE device 10 identifying the optimal RIS-UE beam (e.g., as identified by UE device 10 based on the first and optionally subsequent stage sweeps over RIS-UE beams). RIS 96 may receive the control signal over the control RAT. RIS 96 may form the optimal RIS-UE beam identified by the control signal. If desired, the control signal may add or modify an entry in the codebook of RIS 96.

At operation 198, RIS 96 may reflect THF signals that include wireless data between UE device 10 and AP 6 (e.g., while RIS 96 forms the optimal RIS-UE beam and the optimal RIS-AP beam). For example, RIS 96 may reflect THF signals incident within the formed optimal RIS-AP beam in the direction of the formed optimal RIS-UE beam. Conversely, RIS 96 may reflect THF signals incident within the formed optimal RIS-UE beam in the direction of the formed optimal RIS-AP beam. If desired, processing may loop back to operation 180 periodically or in response to a control signal received from UE device 10 and/or AP 6 (e.g., a control signal generated in response to UE device 10 moving or rotating, in response to UE device 10 and/or AP 6 gathering wireless performance metric data from the THF signals that falls outside a range of acceptable values, or in response to any desired trigger condition).

FIG. 15 is a flow chart of illustrative operations that may be performed by UE device 10 to identify the optimal RIS-UE beam for RIS 96 (with the timing of AP 6 and UE device 10 decoupled from the timing of RIS 96).

At operation 200, UE device 10 may receive confirmation from RIS 96 that RIS 96 is going to begin to sweep over RIS-UE beams. This confirmation may serve as an initial trigger for UE device 10 to begin listening for reference signals reflected off RIS 96. The confirmation may identify the initial time T0 at which AP 6 is to begin transmitting reference signals, at which RIS 96 is going to begin sweeping over RIS-UE beams, and at which UE device 10 is to begin listening for reference signals reflected off RIS 96. UE device 10 may receive the confirmation from RIS 96 in a control signal transmitted over the control RAT, for example.

At operation 202, UE device 10 may begin (at initial time T0) to listen for the reference signals transmitted by AP 6 and reflected off RIS 96. The start of listening for the reference signals may, for example, be triggered by the receipt of the confirmation from RIS 96 (e.g., initial time T0 may be after a predetermined duration from receipt of the confirmation, after a predetermined duration identified in the received confirmation, etc.). RIS 96 may sweep through RIS-UE beams (e.g., during the first stage sweep of FIG. 14) while UE device 10 listens for the reference signals. UE device 10 may also sweep through its UE beams (e.g., by forming/activating each formable UE beam for a UE beam duration TRX in series) and may listen for the reference signals in each step of the sweep over UE beams. Each UE beam in the sweep may be active at least once concurrent with each step in the sweep over RIS-UE beams by RIS 96.

UE device 10 may listen for the reference signals by actively receiving radio-frequency energy using the data RAT and phased antenna array 88, attempting to decode or demodulate wireless signals (e.g., reference signals or SSBs transmitted by AP 6) or data in the received radio-frequency energy, gathering wireless performance metric data from the received radio-frequency energy, comparing the wireless performance metric data to one or more threshold values, etc. The wireless performance metric data may include received power values, signal strength values, received signal strength indicator values, signal-to-noise ratio values, noise floor values, error rate values, signal quality values, decoded or demodulated data, and/or any other desired values that characterize the satisfactory reception of the reference signals at UE device 10.

RIS 96 will scatter the reference signals transmitted by AP 6 in arbitrary directions during most of the sweep over RIS-UE beams. However, at least one of the RIS-UE beams will overlap the current location of UE device 10, causing UE device 10 to receive the reference signals reflected off RIS 96 while that RIS-UE beam is active. UE device 10 may be referred to herein as receiving the reference signals when UE device 10 is able to successfully decode or demodulate the reference signals (e.g., one or more SSBs transmitted by AP 6) or when UE device 10 is able to gather wireless performance metric data from received radio-frequency energy that falls within a range of acceptable wireless performance metric data values. UE device 10 may record (store) the time at which the UE device received the reference signals relative to initial time T0. The corresponding elapsed time after initial time T0 may be referred to herein as time period T1, duration T1, or time T1.

Once RIS 96 has completed the sweep over the RIS-UE beams (e.g., the first stage sweep or after RIS-UE beam sweep time TSWEEP has elapsed from initial time T0), UE device 10 may attempt to identify (e.g., compute, deduce, detect, determine, calculate, generate, etc.) the RIS-UE beam that was formed (active) on RIS 96 based on time period T1 and the predetermined timing of the RIS-UE beam sweep that is already known to UE device 10 (e.g., based on the measured time period T1, initial time T0, RIS-UE beam time period TSLOT, and the predetermined order with which RIS 96 swept over RIS-UE beams). For example, if time period T1 is equal or approximately equal to 1-2 times RIS-UE beam time period TSLOT, UE device 10 may identify that the second RIS-UE beam having beam index m=2 was active when UE device 10 received the reference signals (e.g., that the second RIS-UE beam overlaps the current location of UE device 10). As another example, if time period T1 is equal or approximately equal to 3.5 times RIS-UE beam time period TSLOT, UE device 10 may identify that the fourth RIS-UE beam having beam index m=4 was active when UE device 10 received the reference signals (e.g., that the fourth RIS-UE beam overlaps the current location of UE device 10). If UE device 10 has sufficient confidence that the identified RIS-UE beam is actually the beam that was active on RIS 96 when UE device 10 received the reference signals, UE device 10 may label the second RIS-UE beam as the optimal RIS-UE beam. If desired, the control RAT may be used to convey time-tracking reference signals between UE device 10 and RIS 96 to allow the UE device and RIS to remain time-aligned well enough during a single stage sweep to determine an optimal RIS-UE beam from the time measurement (e.g., of time period T1 and initial time T0).

However, in practice, UE device 10 may have insufficient confidence in its determination of the active RIS-UE beam during reception of the reference signals due to the unknown absolute time offset between UE device 10 and RIS 96 and/or UE device 10 exhibiting a different time drift than RIS 96. A second stage sweep at RIS 96 may help to boost the confidence of the RIS-UE beam determination at UE device 10.

At operation 208, in implementations where the second stage sweep is performed (e.g., after every first stage sweep or when UE device 10 transmits a control signal instructing RIS 96 to perform the second stage sweep prior to performing the first stage sweep), UE device 10 may continue to listen for reference signals transmitted by AP 6 and reflected off RIS 96. RIS 96 may sweep through RIS-UE beams (e.g., each of the RIS-UE beams in reverse direction relative to the first stage sweep or a subset of the RIS-UE beams as identified by UE device 10 in the control signal transmitted to RIS 96) while UE device 10 listens for the reference signals. UE device 10 may also sweep through its UE beams (e.g., by forming/activating each formable UE beam for a UE beam duration TRX in series) and may listen for the reference signals in each step of the sweep over UE beams. Each UE beam in the sweep may be active at least once concurrent with each step in the sweep over RIS-UE beams by RIS 96.

RIS 96 will scatter the reference signals transmitted by AP 6 in arbitrary directions during most of the steps of the second stage sweep. However, at least one of the RIS-UE beams will overlap the current location of UE device 10 (e.g., the same RIS-UE beam that overlapped UE device 10 during the first stage sweep), causing UE device 10 to again receive the reference signals reflected off RIS 96 while that RIS-UE beam is active. UE device 10 may record (store) the time at which the UE device received the reference signals during the second stage sweep relative to initial time T0. This elapsed time after initial time T0 may be referred to herein as time period T2, duration T2, or time T2. Performing the second stage sweep using predetermined timing known to UE device 10 (e.g., using predetermined RIS-UE beam time period TSLOT and a sweep over known/predetermined RIS-UE beams in a known/predetermined order) effectively doubles the statistical sample with which UE device is able to estimate the active RIS-UE beam during the reception of the reference signals, thereby eliminating uncertainty or insufficient confidence in the identification of the active RIS-UE beam by UE device 10. If desired, UE device 10 and RIS 96 may perform additional RIS-UE beam sweeps such as at least a third stage sweep. UE device 10 may, for example, use the control RAT to instruct RIS 96 to perform the third stage sweep when RIS 96 has insufficient confidence in its identification of the active RIS-UE beam during reception of the reference signals during the first and optionally the second stage sweep (e.g., when there is sufficiently high probability that the identified RIS-UE beam is not the optimal RIS-UE beam). If desired, the control signal may identify a subset of the RIS-UE beams for RIS 96 to sweep over in the third stage sweep and an order for the sweep. The subset may include RIS-UE beams at or adjacent to RIS-UE beams at which UE device received the reference signals during the earlier stage sweep(s), for example. Operation 208 may be omitted in implementations or situations where the second stage sweep is not performed.

At operation 210, UE device 10 (e.g., one or more processors on UE device 10) may identify the optimal RIS-UE beam based on initial time T0, time period T1, time period T2 (in situations or implementations where the second stage sweep is performed), and/or the known timing of the RIS-UE beam sweep(s) performed by RIS 96 relative to initial time T0 (e.g., RIS-UE beam time period TSLOT, RIS-UE beam sweep time TSWEEP, the total number M of RIS-UE beams swept over, and the predetermined order over which the RIS-UE beams were swept). The optimal RIS-UE beam may be the RIS-UE beam that overlapped UE device 10 during the first stage sweep and optionally during the second stage sweep. For example, in implementations in which the second stage sweep is performed over the same RIS-UE beams as the first stage sweep but in reverse order, UE device 10 may generate (e.g., calculate, compute, deduce, determine, identify, produce) the beam index m_{RIS-UE} of the optimal RIS-UE beam using the equation: m_{RIS-UE}=M−ceil((T2−T1)/(2*TSLOT)−1)=M−ceil(M*(T2−T1)/(2*TSWEEP)−1), where ceil(is a ceiling function that maps its argument to the least integer greater than or equal to the argument. The RIS-UE beam having (labeled by) beam index m_{RIS-UE} may be the optimal RIS-UE beam and may overlap the current location of UE device 10.

UE device 10 may also identify (e.g., compute, detect, determine, calculate, etc.) the optimal UE beam pointed towards RIS 96. For example, UE device 10 may identify, as the optimal beam, the UE beam with which UE device 10 gathered optimal wireless performance metric data during the RIS-UE beam sweep (e.g., irrespective of the timing of the RIS-UE beam sweep). The optimal UE beam is the UE beam that was active when UE device 10 received the reference signals reflected off UE device 10 during the first stage sweep and optionally during the second stage sweep.

At operation 212, UE device 10 may inform AP 6 of the optimal RIS-UE beam that UE device 10 identified while processing operations 202-210. UE device 10 may also inform AP 6 of the optimal UE beam if desired. UE device 10 may transmit a control signal to AP 6 (e.g., via the control RAT) that identifies the optimal RIS-UE beam (e.g., that includes the beam index m_{RIS-UE} of the identified optimal RIS-UE beam) and/or that identifies the optimal UE beam. AP 6 may use the control RAT to control RIS 96 to form the optimal RIS-UE beam (e.g., while processing operation 168 of FIG. 13). Additionally or alternatively, UE device 10 may configure (program) RIS 96 to form the optimal RIS-UE beam. UE device 10 may, for example, transmit a control signal to RIS 96 (e.g., via the control RAT) that controls the antenna elements on RIS 96 to form the optimal RIS-UE beam, that programs, adds, or updates an entry in the codebook of RIS 96, that instructs RIS 96 to activate the optimal RIS-UE beam from its codebook, etc.

At operation 214, UE device 10 may convey wireless data in THF signals 32 with AP 6 via reflection of the THF signals off RIS 96. UE device 10 may convey the THF signals using the optimal UE beam. RIS 96 may reflect the THF signals using the optimal RIS-UE beam and the optimal RIS-AP beam. UE device 10 may convey the THF signals using the optimal AP beam. If desired, processing may loop back to operation 200 periodically, when UE device 10 moves or rotates, when UE device 10 and/or AP 6 gather wireless performance metric data from the THF signals that falls outside a range of acceptable values, or in response to any desired trigger condition to update the optimal RIS-UE beam and/or the optimal UE beam.

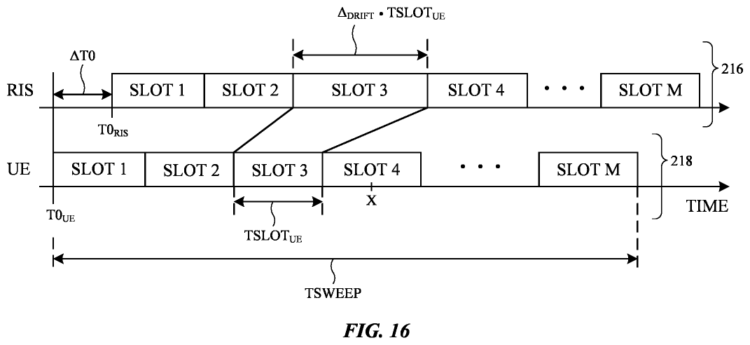

The second stage sweep (and any subsequent stage sweeps) over RIS-UE beams may help to boost the confidence with which UE device 10 identifies the optimal RIS-UE beam by eliminating timing ambiguity associated with unknown absolute time offsets between RIS 96 and UE device 10 and/or associated with RIS 96 exhibiting a different time drift than UE device 10. FIG. 16 is a timing diagram showing how RIS 96 and UE device 10 may exhibit different absolute time offsets and different time drifts.

Portion 216 of FIG. 16 plots one example of timing for RIS 96. Portion 218 of FIG. 16 plots one example of the corresponding timing for UE device 10. As shown by portion 216, RIS 96 may form a respective one of the M RIS-UE beams from the RIS-UE beam sweep during each of a series of M different time slots (e.g., a sweep lasting RIS-UE beam sweep time TSWEEP). As shown by portion 218, UE device 10 may listen for reference signals reflected by RIS 96 during each of the series of M different time slots.

In practice, the absolute timing of RIS 96 may be offset by absolute time offset ΔT0 with respect to the absolute timing of UE device 10. This may cause UE device 10 to begin listening for reference signals at a UE-specific initial time T0_{UE} whereas RIS 96 begins its RIS-UE beam sweep at a RIS-specific initial time T0_{RIS} that is separated from UE-specific initial time T0_{UE} by absolute time offset ΔT0, rather than at the same synchronized initial time T0.

The time drift of RIS 96 may also be different from the time drift of UE device 10. This may cause UE device 10 to expect RIS 96 to be forming a given one of its RIS-UE beams during a UE-specific RIS-UE beam time period TSLOT_{UE} whereas RIS 96 actually forms that RIS-UE beam during a RIS-specific RIS-UE beam time period that is equal to UE-specific RIS-UE beam time period TSLOT_{UE} multiplied by relative drift factor Δ_{DRIFT} that characterizes the difference in time drift between clocking on UE device 10 and RIS 96. If care is not taken, the presence of relative drift factor Δ_{DRIFT} and/or absolute time offset ΔT0 may therefore lead UE device 10 to incorrectly identify the RIS-UE beam that was active on RIS 96 when UE device 10 received reference signals reflected off RIS 96 (e.g., because UE device 10 might incorrectly assume that RIS 96 had a different active RIS-UE beam than RIS 96 actually did when UE device 10 received the reference signals). For example, if UE device 10 receives reference signals at time X (e.g., a time separated from UE-specific initial time T0_{UE} by time period T1), UE device 10 may incorrectly calculate that the fourth RIS-UE beam of the RIS-UE beam sweep (e.g., the RIS-UE beam associated with SLOT 4) was active when UE device 10 received the reference signals even though RIS 96 actually formed the third RIS-UE beam of the RIS-UE beam sweep (e.g., the RIS-UE beam associated with SLOT 3) at that time.

Performing the second stage sweep may effectively eliminate the uncertainty with which UE device 10 identifies the optimal RIS-UE beam despite the presence of relative drift factor Δ_{DRIFT} and/or absolute time offset ΔT0 between the clocking of UE device 10 and RIS 96. Processing may proceed from the first stage sweep to the second stage sweep autonomously (e.g., without additional control signaling between RIS 96 and UE device 10). If desired, UE device 10 may control RIS 96 to perform a third stage sweep when UE device 10 has insufficient confidence in its identified RIS-UE beam. As an example, UE device 10 may control RIS 96 to perform a third stage sweep when UE device 10 determines (e.g., calculates, computes, identifies, etc.) that, for the beam index m_{RIS-UE} of the identified RIS-UE beam from the first and optionally second stage sweep, the following condition is true: Δ_{DRIFT}*(2(M−m_{RIS-UE})+1)>TH, where TH is a predetermined threshold (e.g., design parameter) such as ½. If desired, UE device 10 may instruct RIS 96 to perform the third stage sweep over a specific subset of the RIS-UE beams. The subset may be selected based on the current relative drift factor Δ_{DRIFT} between UE device 10 and RIS 96. The subset of the RIS-UE beams may, for example, include the RIS-UE beams characterized by the set of beam indices: [m_{RIS-UE}−Δm, m_{RIS-UE}+Δm], where Δm=Δ_{DRIFT}*(2(M−m_{RIS-UE})+1)−½. This may, for example, limit the third stage sweep to those RIS-UE beams necessary to resolve the timing ambiguity associated with the current relative drift factor Δ_{DRIFT} between UE device 10 and RIS 96, thereby minimizing the overall time required to perform the second stage sweep.

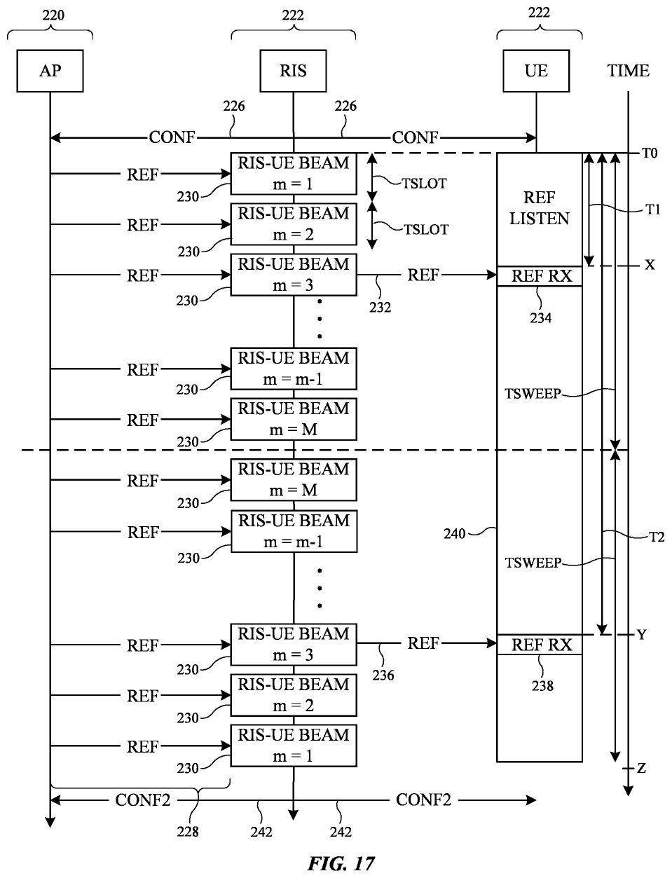

FIG. 17 is a timing diagram illustrating the operations of AP 6, RIS 96, and UE device 10 associated with the discovery of the optimal RIS-UE beam by UE device 10. The timing diagram of FIG. 17 may, for example, correspond to the operations of FIGS. 13-15. In the example of FIG. 17, RIS 96 performs both a first stage sweep and a second stage sweep (e.g., in an implementation where operation 194 of FIG. 14 and operation 208 of FIG. 15 are performed), where the second stage sweep includes a sweep over each of the RIS-UE beams from the first stage sweep but in a reverse order with respect to the first stage sweep.

Portion 220 of FIG. 17 illustrates the operation of AP 6. Portion 222 of FIG. 17 illustrates the operation of RIS 96. Portion 224 of FIG. 17 illustrates the operation of UE device 10. Signaling between AP 6, UE device 10, and RIS 96 is illustrated by arrows extending between portions 220-224. Time is plotted on the vertical axis of FIG. 17.

As shown by arrows 226, RIS 96 may transmit control signals that include confirmation CONF of the beginning of the RIS-UE beam sweep to AP 6 and UE device 10 (e.g., at operation 180 of FIG. 14). At initial time T0, RIS 96 may begin the first stage sweep over its M RIS-UE beams from an initial RIS-UE beam having index m=1 to an Mth RIS-UE beam having index m=M, as shown by blocks 230. RIS 96 may form each RIS-UE beam in the sweep during a respective RIS-UE beam time period TSLOT. The first stage sweep may end after time after RIS-UE beam sweep time TSWEEP has elapsed from initial time T0.

As shown by arrows 228, AP 6 may transmit reference signals REF to RIS 96 while each RIS-UE beam from the sweep is active. At initial time T0, UE device 10 may begin to listen for reference signals REF transmitted by RIS 96 and reflected off RIS 96, as shown by block 240. In the example of FIG. 17, the RIS-UE beam having beam index m=3 overlaps the current location of UE device 10. RIS 96 therefore reflects reference signals REF towards UE device 10 within the RIS-UE beam having beam index m=3, as shown by arrow 232. At time X, UE device 10 may receive the reference signals REF that reflected off RIS 96 within the RIS-UE beam having beam index m=3, as shown by block 234. UE device 10 may record the time period T1 relative to initial time T0 at which the reference signals were received during the first stage sweep (e.g., where time period T1=X−T0). RIS 96 may continue to sweep over its RIS-UE beams until each RIS-UE beam has been active (e.g., until RIS-UE beam sweep time TSWEEP has elapsed from initial time T0).

Once RIS-UE beam sweep time TSWEEP has elapsed from initial time T0, RIS 96 may begin the second stage sweep over its M RIS-UE beams. The second stage sweep may end after RIS-UE beam sweep time TSWEEP has elapsed from the beginning of the second stage sweep (e.g., after 2*TSWEEP has elapsed from initial time T0). The second stage sweep may be performed over the same RIS-UE beams from the first stage sweep but in reverse order. In other words, RIS 96 may sweep over the RIS-UE beams from the Mth RIS-UE beam having index m=M to the initial RIS-UE beam having index m=1, as shown by blocks 230. Performing the second stage sweep in reverse order may, for example, minimize the time required to discover the optimal RIS-UE beam while also minimizing the risk that UE device 10 erroneously identifies the optimal RIS-UE beam relative to implementations where the second stage sweep is performed in other orders such as the same order as the first stage sweep.

As shown by arrows 228, AP 6 may continue to transmit reference signals REF to RIS 96 while each RIS-UE beam from the second stage sweep is active. As shown by block 240, UE device 10 may continue to listen to reference signals REF during the second stage sweep. During the second stage sweep, RIS 96 may reflect reference signals REF towards UE device 10 within the RIS-UE beam having beam index m=3, as shown by arrow 236. At time Y, UE device 10 may receive the reference signals REF that reflected off RIS 96 within the RIS-UE beam having beam index m=3, as shown by block 238. UE device 10 may record the time period T2 relative to initial time T0 at which the reference signals were received during the second stage sweep (e.g., where time period T2=Y−T0). RIS 96 may continue to sweep over its RIS-UE beams until each RIS-UE beam has been active during the second stage sweep (e.g., until time Z or until RIS-UE beam sweep time 2*TSWEEP has elapsed from initial time T0).

Once the second stage sweep has ended, RIS 96 may transmit a control signal CONF2 that confirms to UE device 10 and AP 6 that the RIS-UE beam sweep has ended. UE device 10 may identify the optimal RIS-UE beam and its corresponding beam index m_{RIS}-UE based on initial time T0, the time period T1 between initial time T0 and time X when UE device 10 received reference signals REF during the first stage sweep, the time period T2 between initial time T0 and time Y when UE device 10 received reference signals REF during the second stage sweep, and/or the predetermined (known) timing of the first and second stage sweeps (e.g., using knowledge that the first stage sweep proceeds in order from m=1 to m=M with each step lasting for RIS-UE beam time period TSLOT and knowledge that the second stage sweep proceeds in order from m=M to m=1 with each step lasting for RIS-UE beam time period TSLOT). UE device 10 may identify the beam index m_{R}IS-U_{E} of the optimal RIS-UE beam using the equation m_{RIS-UE}=M−ceil((T2−T1)/(2*TSLOT)−1)=M−ceil(M*(T2−T1)/(2*TSWEEP)−1), for example. In the example of FIG. 17, UE device 10 may identify that the optimal RIS-UE beam is the RIS-UE beam having the index m_{RIS-UE}=3, since that was the RIS-UE beam active for each instance during which UE device 10 received reference signals reflected off RIS 96. By performing the second stage sweep, UE device 10 may eliminate uncertainty in its selection of the optimal RIS-UE beam associated with unknown absolute time offsets and different time drifts between UE device 10 and RIS 96, and UE device 10 may have high confidence that the optimal RIS-UE beam found based on time periods T1 and T2 is the correct RIS-UE beam oriented towards the present location of UE device 10.

If desired, RIS 96 may perform a third UE beam sweep over RIS-UE beams (e.g., a third stage sweep) after completing the second stage sweep. For example, UE device 10 may identify (e.g., compute, calculate, etc.) timing uncertainty between RIS 96 and UE device 10 and/or associated with the currently-identified optimal RIS-UE beam and may instruct RIS 96 to perform the third RIS-UE beam sweep over the subset of RIS-UE beams when the timing uncertainty exceeds a threshold value (e.g., when Δ_{DRIFT}*(2(M−m_{RIS-UE})+1)>TH). If desired, the RIS-UE beams in the first and second stage sweeps may be coarse RIS-UE beams whereas the RIS-UE beams in the third RIS-UE beam sweep is a fine RIS-UE beam sweep at and/or around the currently-identified optimal RIS-UE beam. If desired, the RIS-UE beams in the first stage sweep may be coarse RIS-UE beams whereas the RIS-UE beams in the second stage sweep are fine RIS-UE beams (e.g., UE device 10 and RIS 96 may convey additional control signals to coordinate the timing of additional stage sweeps). The example of FIG. 17 is illustrative and non-limiting. Other control schemes may be used. The first, second, and subsequent stage sweeps may be over any of the RIS-UE beams of RIS 96 in any desired orders. One or more of the sweep stages may involve sweeping over one or more of the same RIS-UE beam more than once.

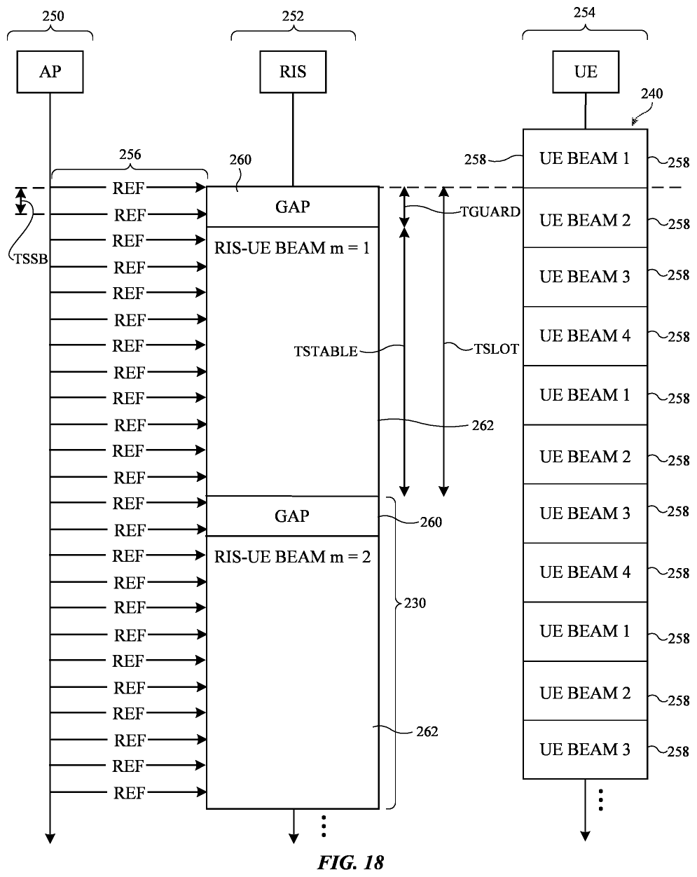

In block 240 of FIG. 17, UE device 10 may perform scans over UE beams for each active RIS-UE beam to identify the optimal UE beam oriented towards RIS 96. FIG. 18 is a timing diagram showing one example of how UE device 10 may scan over UE beams for each RIS-UE beam. Portion 230 of FIG. 18 illustrates the operation of AP 6. Portion 252 of FIG. 18 illustrates the operation of RIS 96. Portion 254 of FIG. 18 illustrates the operation of UE device 10. Signaling between AP 6, UE device 10, and RIS 96 is illustrated by arrows extending between portions 250-254. Time is plotted on the vertical axis of FIG. 18.

As shown in FIG. 18, each step in the RIS-UE beam sweep (e.g., each block 230) may last for RIS-UE beam time period TSLOT. Each step in the RIS-UE beam sweep (e.g., each block 230) may include a reconfiguration gap period 260 followed by a stable period 262. Reconfiguration gap period 260 may allow time for RIS 96 to adjust (re-program) its antenna elements 100 to form the corresponding RIS-UE beam. RIS 96 may reflect reference signals REF over the corresponding RIS-UE beam during stable period 262. Reconfiguration gap period 260 may have a predetermined duration (e.g., guard period) TGUARD. Stable period 262 may have a predetermined duration TSTABLE. RIS-UE beam time period TSLOT may be equal to TSTABLE+TGUARD.

As shown by arrows 256, AP 6 may transmit reference signals REF towards RIS 96 multiple times during each block 230. For example, AP 6 may transmit multiple SSBs towards RIS 96 during each block 230. Each SSB transmission may last for a corresponding duration TSSB. While UE device 10 listens for reference signals REF (e.g., at block 240), UE device 10 may sweep over its UE beams, as shown by blocks 258. UE device 10 may listen for reference signals REF within the active UE beam. Each UE beam may have a UE beam duration TRX. In general, UE device 10 may switch through UE beams much faster than RIS 96 switches through RIS-UE beams.

UE device 10 may switch through UE beams sufficiently fast so that each UE beam is active at least once during the stable period 262 of each active RIS-UE beam (e.g., concurrent with each block 230). In the example of FIG. 18, UE device 10 has four UE beams (a first UE beam UE BEAM 1, a second UE beam UE BEAM 2, a third UE beam UE BEAM 3, and a fourth UE beam UE BEAM 4). Given the decoupled timing of RIS 96 and UE device 10, UE BEAM 3 is the first UE beam that happens to be active within the stable period 262 while the RIS-UE beam labeled by index m=1 is concurrently active (in the example of FIG. 18). However, since UE device 10 can switch through its UE beams much faster than RIS 96 switches through RIS-UE beams, UE device 10 may continue to sweep through its UE beams quickly enough so that each of the UE beams is active at least once for an entirety of UE beam duration TRX during the stable period 262 of the RIS-UE beam labeled by index m=1. Similarly, the UE device may sweep through each of its UE beams during each subsequent step of the RIS-UE beam sweep. If desired, UE device 10 may sweep through coarse UE beams and then may sweep through fine UE beams (e.g., at or around an optimal coarse UE beam) concurrent with each RIS-UE beam being active or concurrent with any desired portion of one or more of the RIS-UE beam sweep stages.

To help ensure that UE beam 10 is able to characterize each of its UE beams for each step of the RIS-UE beam sweep (e.g., to ensure that UE device 10 receives a reference signal while the RIS-UE beam pointed towards UE device 10 is active), UE beam duration TRX may be greater than or equal to 2*TSSB. As an example, when TSSB is 1 microsecond, duration TGUARD is 5 microseconds, UE beam duration TRX is 2 microseconds, and duration TSTABLE is 20 micro seconds, UE device 10 may be able to sweep over up to 10 UE beams during the stable period 262 of each RIS-UE beam in the RIS-UE beam sweep. The example of FIG. 18 in which UE device 10 sweeps over four UE beams is illustrative and, in general, UE device 10 may sweep over any desired number of UE beams depending on the signal timing durations. If desired, UE device 10 may spend more time detecting the correct beam setting for multiple SSBs (e.g., confirming detection, allowing signaling of AP-RIS switching time relationships to AP 6 based on the detected SSB indices, etc.). The example of FIG. 18 is non-limiting. Other control schemes may be used. If desired, the operations described herein as being performed by UE device 10 may alternatively be performed by AP 6 whereas the operations described herein as being performed by AP 6 may be performed by UE device 10.

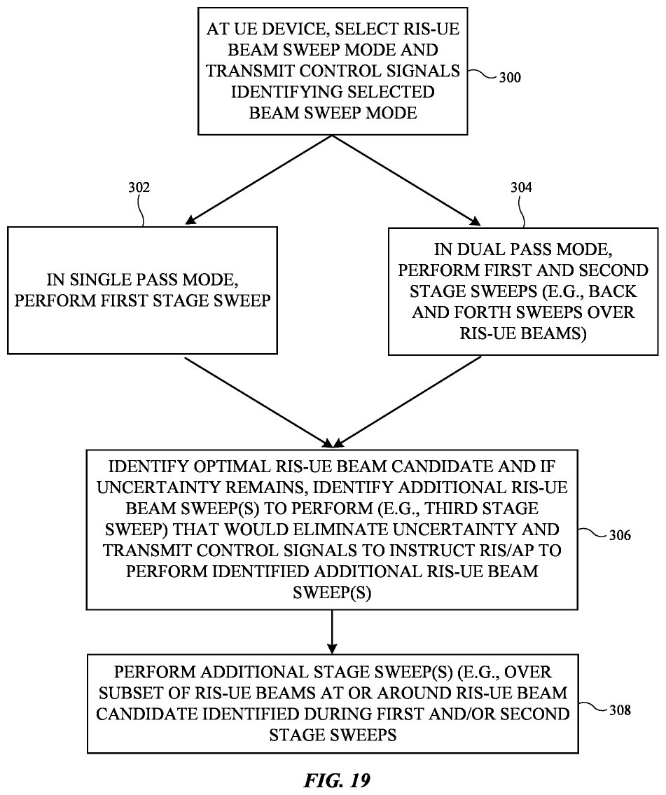

FIG. 19 is a flow chart of operations that may be performed by UE device 10 to control how RIS 96 performs RIS-UE beam sweeps at operations 184-194 of FIG. 14. The operations of FIG. 19 may allow UE device 10 to preconfigure the RIS-UE beam sweep of RIS 96 prior to beginning the first stage sweep, thereby minimizing the amount of control signaling performed during or between sweeps.

At operation 300, UE device 10 may select a RIS-UE beam sweep mode. The RIS-UE beam sweep mode may be a single pass mode, in which only the first stage sweep is performed, or may be a dual pass mode, in which the first and second stage sweeps are performed. UE device 10 may use the control RAT to transmit a control signal to RIS 96 and AP 6 that identify which RIS-UE beam sweep mode will be used. Operation 300 may be performed prior to operation 202 of FIG. 15, for example.

When the single pass mode is to be used, processing may proceed to operation 302. At operation 302, RIS 96 may perform the first stage sweep while UE device 10 listens for reflected reference signals (e.g., at operations 202-204 of FIG. 15). When the dual pass mode is to be used, processing may proceed from operation 300 to operation 304. At operation 304, RIS 96 may perform the first stage sweep and then the second stage sweep while UE device 10 listens for reflected reference signals (e.g., at operations 202-208 of FIG. 15). The second stage sweep may be the same as the first stage sweep but in reverse order over the RIS-UE beams of the first stage sweep (e.g., the first and second stage sweeps may represent a single back and forth sweep over the RIS-UE beams, as shown in the example of FIG. 17).

At operation 306, UE device 10 may process the received reference signal(s) and the corresponding timing with which the reference signal(s) were received relative to initial time T0 to identify a candidate optimal RIS-UE beam. UE device 10 may identify an amount of timing uncertainty associated with the candidate optimal RIS-UE beam. If the amount of uncertainty exceeds a threshold, UE device 10 may identify one or more additional RIS-UE beam sweeps to perform. For example, UE device 10 may identify a third stage sweep to perform. The third stage sweep may be over a subset of the beams from the first and second stage sweeps, may include finer beams than the first and second stage sweeps, and/or may include other beams not tested in the first and second stage sweeps. UE device 10 may use the control RAT to transmit a control signal that instructs RIS 96 to perform the additional stage sweeps. The control signal may identify a subset of the RIS-UE beams for RIS 96 to sweep over in the additional stage sweep(s) and an order for the sweep(s). The subset may include RIS-UE beams at or adjacent to the identified candidate RIS-UE beam, for example.

At operation 308, RIS 96 may perform the additional stage sweep(s) while UE device 10 listens for reflected reference signals (e.g., at operation 208 of FIG. 15). UE device 10 may use the timing of reference signals received during the additional stage sweep(s) and the predetermined timing of the additional stage sweep(s) to identify the optimal RIS-UE beam (e.g., with greater confidence than the candidate RIS-UE beam).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

UE device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-13 may be performed by the components of UE device 10, RIS 96, and/or AP 6 using software, firmware, and/or hardware (e.g., dedicated circuitry or hardware). Software code for performing these operations may be stored on non-transitory computer readable storage media (e.g., tangible computer readable storage media) stored on one or more of the components of UE device 10, RIS 96, and/or AP 6. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of UE device 10, RIS 96, and/or AP 6. The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. A method of operating a first electronic device to wirelessly communicate with a second electronic device via reflection off a third electronic device, the method comprising:
receiving, using a receiver, a first control signal from the third electronic device that identifies a first time;
receiving, using one or more antennas at a second time subsequent to the first time, a radio-frequency signal transmitted by the second electronic device and reflected off the third electronic device; and
transmitting, using a transmitter, a second control signal that identifies a signal beam of the third electronic device associated with a duration between the first time and the second time.

2. The method of claim 1, further comprising:
conveying, after transmitting the second control signal, wireless data with the second electronic device via reflection off the third electronic device using the signal beam identified by the second control signal.

3. The method of claim 1, further comprising:
beginning, using the one or more antennas at the first time, to listen for radio-frequency signals transmitted by the second electronic device via reflection off the third electronic device.

4. The method of claim 1, wherein transmitting the second control signal comprises transmitting the second control signal to the second electronic device.

5. The method of claim 1, wherein transmitting the second control signal comprises transmitting the second control signal to the third electronic device, the method further comprising:
using the second control signal to control antenna elements on the third electronic device to form the signal beam associated with the duration between the first time and the second time.

6. The method of claim 1, wherein receiving the radio-frequency signal comprises receiving the radio-frequency signal using a first radio access technology (RAT) and transmitting the second control signal comprises transmitting the second control signal using a second RAT that is different from the first RAT.

7. The method of claim 6, wherein the radio-frequency signal is at a frequency greater than or equal to 100 GHz.

8. The method of claim 1, further comprising:
receiving, using the one or more antennas at a third time subsequent to the second time, an additional radio-frequency signal transmitted by the second electronic device and reflected off the third electronic device, wherein the signal beam is associated with an additional duration between the first time and the third time.

9. The method of claim 8, further comprising:
controlling the third electronic device to sweep over a set of signal beams of antenna elements on the third electronic device, the additional radio-frequency signals being received while the third electronic device sweeps over the set of signal beams.

10. The method of claim 9, wherein controlling the third electronic device to sweep over the set of signal beams comprises controlling the third electronic device to sweep over the set of signal beams when a timing uncertainty between the first electronic device and the third electronic device exceeds a threshold value.

11. The method of claim 9, wherein the set of signal beams is selected based on the radio-frequency signal received at the second time.

12. The method of claim 1, wherein receiving the radio-frequency signal comprises receiving the radio-frequency signal while the third electronic device sweeps over a set of signal beams, the method further comprising:
identifying, using one or more processors, the signal beam based on the duration and an additional duration with which the third electronic device forms each signal beam in the set of signal beams during the sweep over the set of signal beams by the third electronic device.

13. The method of claim 1, wherein the one or more antennas form part of a phased antenna array and wherein receiving the radio-frequency signal comprises receiving, using the phased antenna array, the radio-frequency signal while the third electronic device sweeps over a set of signal beams, the method further comprising:
sweeping the phased antenna array over a set of receive signal beams formable by the phased antenna array, wherein the phased antenna array forms each receive signal beam in the set of receive signal beams concurrent with the third electronic device forming each signal beam in the set of signal beams during the sweep over the set of signal beams by the third electronic device.

14. A method of operating a first electronic device to reflect radio-frequency signals between a second electronic device and a third electronic device, the method comprising:
sweeping an array of antenna elements over a first set of signal beams concurrent with the array of antenna elements reflecting radio-frequency signals transmitted by the second electronic device;
after sweeping the array of antenna elements over the first set of signal beams, sweeping the array of antenna elements over a second set of signal beams concurrent with the array of antenna elements reflecting the radio-frequency signals transmitted by the second electronic device; and
receiving, using a receiver after sweeping the array of antenna elements over the second set of signal beams, a control signal that identifies a signal beam from the first and second sets of signal beams that overlaps the third electronic device.

15. The method of claim 14, further comprising:
configuring, using adjustable devices, the array of antenna elements to form the signal beam identified by the control signal; and
reflecting, using the array of antenna elements and the signal beam, wireless data between the first electronic device and the second electronic device.

16. The method of claim 14, wherein the first set of signal beams includes a coarse set of signal beams and the second set of signal beams includes a fine set of signal beams.

17. The method of claim 14, wherein the second set of signal beams includes a subset of the first set of signal beams.

18. The method of claim 14, wherein sweeping the array of antenna elements over the first set of signal beams includes sweeping the array of antenna elements over the signal beams in the first set of signal beams in a first order, and sweeping the array of antenna elements over the second set of signal beams includes sweeping the array of antenna elements over the signal beams in the first set of signal beams in a second order that is a reverse of the first order.

19. The method of claim 14, wherein the radio-frequency signals reflected by the array of antenna elements are transmitted by the second electronic device using a first radio access technology (RAT) and receiving the control signal comprises receiving the control signal from the second electronic device or the third electronic device using a second RAT that is different from the first RAT.

20. A user equipment device comprising:
a phased antenna array configured to
listen, beginning at a first time, for radio-frequency signals transmitted by a wireless access point and reflected off a reconfigurable intelligent surface (RIS) concurrent with a sweep by the RIS over a set of signal beams formable by antenna elements on the RIS, and
receive, at a second time subsequent to the first time, the radio-frequency signals transmitted by the wireless access point and reflected off the RIS; and
one or more processors configured to
select a signal beam from the set of signal beams based on a time period between the first time and the second time and based on a predetermined timing of the sweep by the RIS over the set of signal beams, and
transmit, to the wireless access point, a control signal that identifies the selected signal beam.
